(19) United States
(12) Patent Application Publication
(10) Pub. No.: US 2026/0287088 A1
(43) Pub. Date: Sep. 24, 2026

(54) FASTENER SYSTEM AND METHOD

(71) Applicant: Preformed Line Products Company, Cleveland, OH (US)

(72) Inventors: Roman Spacek, Prostejov (CZ); Chris Grubish, Cleveland, OH (US); Jaroslav Smatera, Boskovice (CZ)

(21) Appl. No.: 19/572,007

(22) Filed: Mar. 19, 2026

Related U.S. Application Data
(60) Provisional application No. 63/775,265, filed on Mar. 20, 2025.

(51) Int. Cl. F16L 3/10; F16L 3/22

(52) U.S. Cl. CPC F16L 3/10; F16L 3/22

(57) ABSTRACT

A fastener includes a base, a cover, and a clip. The base defines a slot, and the cover is fixed with the base, where the base and the cover define a hole configured for receiving a cable in a longitudinal direction of the fastener. The clip includes a first clip end disposed in the slot, and includes a second clip end extended from the first clip end, toward the cover, and into the opening in a direction perpendicular to the longitudinal direction. The clip pivots between a locked position and an unlocked position with respect to the cover when the cable is pulled through the hole.

### CROSS REFERENCE TO RELATED APPLICATIONS

The application claims priority to U.S. Provisional Patent Application No. 63/775,265, filed Mar. 20, 2025, entitled “FASTENER SYSTEM AND METHOD,” of which is incorporated herein by reference in its entirety.

### BACKGROUND

Modern information technology (IT) systems demand efficient and organized cable management that enables maintaining system performance, ensuring safety, and facilitating maintenance and upgrades. Furthermore, the proliferation of high-speed data cables, fiber optics, power cables, and other wiring and ducts associated with computer servers, networking equipment, and data centers has created a significant challenge in managing these cables effectively. Poor cable management in view of such a challenge can lead to a variety of issues including reduced airflow, increased risk of overheating, difficulty in troubleshooting and maintaining systems, and a cluttered working environment that impairs the overall efficiency of IT operations and installations.

Existing cable management solutions, such as cable ties and cable organizers often fall short in addressing a full range of needs in a dynamic or high-density IT environment. Many of these solutions are either too rigid, leading to difficulties in adjusting or rerouting cables as needed, or too simplistic, failing to accommodate the varying sizes and types of cables used in contemporary systems. Furthermore, traditional cable management products can be time-consuming to install and remove, leading to increased downtime during system maintenance or upgrades.

### SUMMARY

In one aspect, a fastener system is provided comprising a support structure, a retention clip comprising a support portion configured to be disposed in a slot of the support structure, and a linear drive mechanism configured to convert an input motion into linear displacement of the retention clip toward or away from the support structure to clamp or release a cable or duct between the retention clip and the support structure.

In some embodiments, the linear drive mechanism comprises a threaded clamping mechanism including a threaded stud and a threaded nut, wherein rotation of the threaded nut causes the threaded nut to move axially along the threaded stud to drive the retention clip toward or away from the support structure. In some embodiments, the threaded nut includes a body having a threaded hole extending through a center of the body, and a groove formed in an exterior surface of the body, the groove configured to engage with a clip slot defined by the retention clip. In some embodiments, a width of the clip slot is slightly larger than a thickness of the retention clip to permit free rotation of the threaded nut relative to the retention clip after assembly. In some embodiments, the threaded nut includes an external surface geometry configured to provide an installer with additional grip when tightening or loosening the threaded nut, the external surface geometry comprising a knob extending radially from the body. In some embodiments, the retention clip includes one or more teeth configured to compress against and grip the cable or duct. In some embodiments, a single retention clip is configured to restrain a plurality of cables or ducts simultaneously. In some embodiments, the retention clip is engaged with a plurality of linear drive mechanisms.

In another aspect, a fastener is provided comprising a base that defines a plurality of slots arranged at different positions, a cover fixed with the base wherein the base and the cover define a hole configured for receiving a cable in a longitudinal direction of the fastener, and a clip that includes a first clip end disposed in one of the plurality of slots and a second clip end extended from the first clip end toward the cover and into the hole in a direction perpendicular to the longitudinal direction, wherein the clip pivots between a locked position and an unlocked position with respect to the cover when the cable is pushed or pulled through the hole.

In some embodiments, the plurality of slots are configured to retain the clip at a variety of distances from an interior surface of the cover. In some embodiments, the plurality of slots are offset from each other in the longitudinal direction of the fastener in regular intervals and arranged at a variety of positions in a front-back direction of the fastener. In some embodiments, the second clip end forms a concave edge along an outer perimeter of the clip, the concave edge configured to increase a contact surface between the second clip end and the cable. In some embodiments, the base includes prongs configured to snap fit with a support structure for mounting the fastener. In some embodiments, the cover includes guide rails configured to slide into guide channels defined by the base to fix the cover with the base. In some embodiments, the cover includes cover tabs configured to restrict longitudinal movement of the cover relative to the base.

In yet another aspect, a fastener is provided comprising a base including base inner walls that define an interior, the base inner walls including a pair of base side walls extended in a front-back direction and a base back wall extended between the base side walls in a left-right direction, and a wedge having a first flange and a second flange extended oppositely from each other in the left-right direction, wherein the base side walls define channels that extend at an angle offset from vertical in the front-back direction and the channels are configured to receive the flanges in a sliding relationship that drives the wedge toward the base back wall in the front-back direction.

In some embodiments, the fastener further comprises a locking mechanism configured to prevent the wedge from moving away from the base back wall. In some embodiments, the locking mechanism comprises a clamp having prongs with ridges configured to snap-fit within detents defined by the base side walls. In some embodiments, the locking mechanism comprises pawls extending from lateral sides of the wedge, the pawls configured to engage with teeth defined by the base side walls in a ratcheting relationship. In some embodiments, the wedge defines a passage configured to receive a clip, the clip having a blade configured to extend beyond a wedge back surface to engage a cable with concentrated grip force.

According to one aspect, a fastener includes a base, a cover, and a clip. The base defines a slot, and the cover is fixed with the base, where the base and the cover define a hole configured for receiving a cable in a longitudinal direction of the fastener. The clip includes a first clip end disposed in the slot, and includes a second clip end extended from the first clip end, toward the cover, and into the opening in a direction perpendicular to the longitudinal direction. The clip pivots between a locked position and an unlocked position with respect to the cover when the cable is pushed or pulled through the hole.

According to one aspect, a fastener includes a base including base inner walls that define an interior. The base inner walls include a pair of base side walls extended in a front-back direction, and include a base back wall extended between the base side walls in a left-right direction. The fastener also includes a wedge having a first flange and a second flange extended oppositely from each other in the left-right direction. The base side walls define channels that extend at an angle offset from vertical in the front-back direction, and the channels receive the flanges in a sliding relationship that drives the wedge toward the base back wall in the front-back direction.

The innovation described herein describes a fastening system that offers flexibility in cable routing, and ease of installation and removal. In addition to other described features, functions and benefits, the fastening system as described herein can enable secure and efficient management of a variety of cable (and duct) types, sizes and shapes.

### BRIEF DESCRIPTION OF THE DRAWINGS

FIG. 1 is a perspective view of an example fastener including a base and a cover in accordance with aspects of the innovation.

FIG. 2 is a perspective view of the fastener of FIG. 1 with the cover lifted from the base.

FIG. 3 is a top view of the fastener of FIG. 1.

FIG. 4 is a bottom view of the fastener of FIG. 1.

FIG. 5 is a cross-sectional view of the fastener of FIG. 1 with a clip disposed in an unlocked position.

FIG. 6 is a cross-sectional view of the fastener of FIG. 1 with a clip disposed in a locked position.

FIG. 7 is a perspective view of the fastener of FIG. 1 with a cable pulled upward through an opening in the fastener.

FIG. 8 is a cross-sectional view of the fastener of FIG. 1 with the cable pulled upward through the opening.

FIG. 9 is a cross-sectional view of the fastener of FIG. 1 with the cable pulled downward through the opening.

FIG. 10 is a perspective view of an example clip in accordance with aspects of the innovation.

FIG. 11 is an enlarged partial perspective view of a cabinet assembly including the fastener and the cable in accordance with aspects of the innovation.

FIG. 12 is an enlarged partial perspective view of the cabinet assembly loaded with fasteners and cables to a full capacity in accordance with aspects of the innovation.

FIG. 13 is a perspective view of the cabinet assembly in accordance with aspects of the innovation.

FIG. 14A is a perspective view of an example fastener in accordance with aspects of the innovation.

FIG. 14B is a front view of the fastener of FIG. 14A.

FIG. 14C is a perspective view of an example base in accordance with aspects of the innovation.

FIG. 14D is a perspective view of an example clamp in accordance with aspects of the innovation.

FIG. 14E is a perspective view of an example wedge in accordance with aspects of the innovation.

FIG. 15A is a perspective view of an example fastener in accordance with aspects of the innovation.

FIG. 15B is a perspective view of an example base in accordance with aspects of the innovation.

FIG. 15C is a perspective view of an example clamp in accordance with aspects of the innovation.

FIG. 15D is a perspective view of an example wedge in accordance with aspects of the innovation.

FIG. 16A is a perspective view of an example fastener in accordance with aspects of the innovation.

FIG. 16B is a side view of the fastener of FIG. 16A.

FIG. 17A is a side view of an example fastener in a locked position in accordance with aspects of the innovation.

FIG. 17B is a side view of the fastener of FIG. 17A in an unlocked position in accordance with aspects of the innovation.

FIG. 17C is a perspective view of the fastener of FIG. 17A.

FIG. 17D is a perspective view of an example base in accordance with aspects of the innovation.

FIG. 17E is a perspective view of an example wedge in accordance with aspects of the innovation.

FIG. 17F is a perspective view of an example clamp in accordance with aspects of the innovation.

FIG. 17G is a top view of the wedge of FIG. 17E.

FIG. 17H is a side view of the wedge of FIG. 17E.

FIG. 17I is an exploded view of the fastener of FIG. 17A.

FIG. 18A is a perspective view of an example fastener in accordance with aspects of the innovation.

FIG. 18B is a front perspective view of the fastener of FIG. 18A.

FIG. 18C is a top view of the fastener of FIG. 18A.

FIG. 18D is a side view of the fastener of FIG. 18A.

FIG. 18E is a perspective view of the fastener of FIG. 18A.

FIG. 18F is a front perspective view of an example wedge in accordance with aspects of the innovation.

FIG. 18G is a top perspective exploded view of the fastener of FIG. 18A.

FIG. 18H is a side perspective view of the wedge of FIG. 18F.

FIG. 18I is a bottom view of the fastener of FIG. 18A with an example cable in accordance with aspects of the innovation.

FIG. 18J is a top view of the fastener of FIG. 18A with the cable of FIG. 18I.

FIG. 18K is a front view of the fastener of FIG. 18A with the cable of FIG. 18I.

FIG. 19A is a perspective view of an example fastener in accordance with aspects of the innovation.

FIG. 19B is a side view of the fastener of FIG. 19A.

FIG. 19C is a perspective view of an example base in accordance with aspects of the innovation.

FIG. 19D is a perspective view of an example wedge in accordance with aspects of the innovation.

FIG. 19E is a perspective view of an example cap in accordance with aspects of the innovation.

FIG. 19F is a side view of the cap of FIG. 19E.

FIG. 20 is a perspective view of an example embodiment in accordance with aspects of the innovation.

FIG. 21 is a perspective view of an example embodiment in accordance with aspects of the innovation.

FIG. 22 is a perspective view of an example embodiment of the retention clip in accordance with aspects of the innovation.

FIG. 23 is a perspective view of an example embodiment of the retention clip in accordance with aspects of the innovation.

FIG. 24A is a perspective view of an example embodiment of the threaded nut in accordance with aspects of the innovation.

FIG. 24B is a side view of an example embodiment of the threaded nut in accordance with aspects of the innovation.

FIG. 25 is a perspective view of an example embodiment in accordance with aspects of the innovation.

FIG. 26 is a perspective view of an example embodiment in accordance with aspects of the innovation.

FIG. 27A is a perspective view of an example embodiment in accordance with aspects of the innovation.

FIG. 27B is a perspective view of an example embodiment in accordance with aspects of the innovation.

FIG. 27C is a perspective view of an example embodiment in accordance with aspects of the innovation.

### DETAILED DESCRIPTION

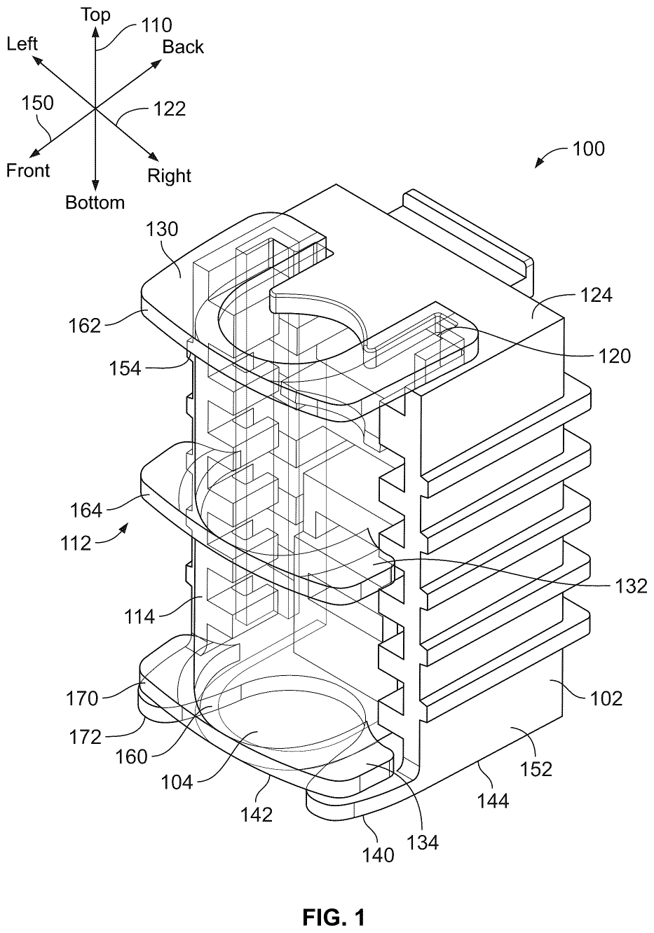

It should, of course, be understood that the description and drawings herein are merely illustrative and that various modifications and changes can be made in the structures disclosed without departing from spirit and scope of the subject disclosure. Referring now to the drawings, wherein like numerals refer to like parts throughout the several views, in accordance with an aspect of the innovation, FIG. 1 illustrates a fastener 100 including a base 102 supporting a cover 104. The cover 104 is received by the base 102 in a longitudinal direction of the fastener 100, indicated by an arrow 110. As depicted in FIG. 1, the longitudinal direction of the fastener 100 is a vertical direction when the fastener 100 is in an upright position.

The cover 104 includes a plurality of cover tabs 112 extended from an exterior surface 114 of the cover 104, and configured for engaging the base 102 and facilitating being gripped by a user. In this regard, the plurality of cover tabs 112 includes a first cover tab 120 extended in a lateral left-right direction of the fastener 100 perpendicular to the longitudinal direction, indicated by an arrow 122.

The first cover tab 120 engages and abuts a base top face 124 in the longitudinal direction of the fastener 100. With this construction, the first cover tab 120 and the base top face 124 restrict movement of the cover 104 downward in the longitudinal direction of the fastener 100 relative to the base 102, beyond an assembled position with the base 102 illustrated in FIG. 1. More specifically, the first cover tab 120 and the base top face 124 prevent a cover top face 130 from moving downward passed the base top face 124 when the cover 104 is received in the base 102.

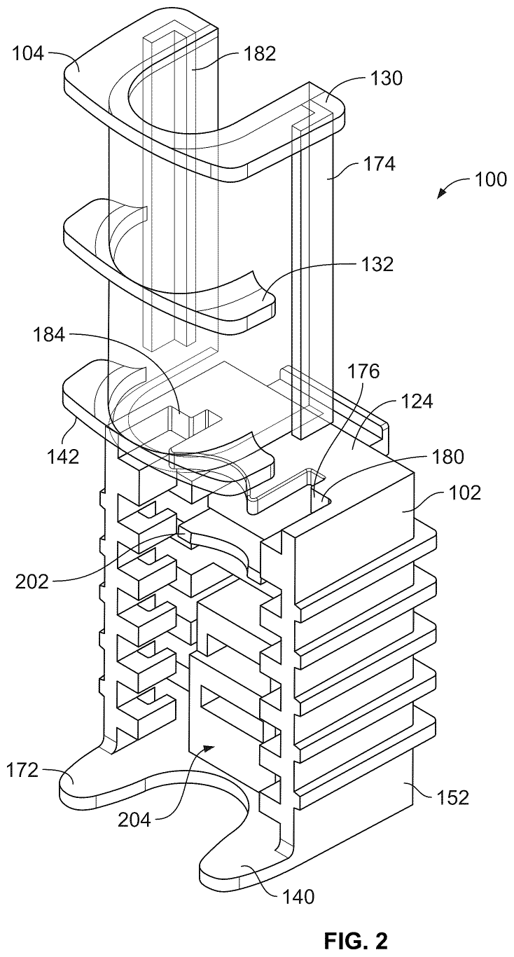

The plurality of cover tabs 112 includes a second cover tab 132 extended in the left-right direction of the fastener 100, and offset downward from the first cover tab 120 in the longitudinal direction of the fastener 100. The second cover tab 132 forms an irregularity on the exterior surface 114 of the cover 104 configured for being gripped by a user. With this construction, as shown in FIG. 2, a user may grip the cover 104 at the second cover tab 132, and lift the cover 104 upward relative to the base 102 in the longitudinal direction of the fastener 100. In this manner, the cover 104 may be assembled and disassembled with the base 102 by moving the cover 104 in the longitudinal direction of the fastener 100 relative to the base 102.

Referring back to FIG. 1, the plurality of cover tabs 112 includes a third cover tab 134 extended in the left-right direction of the fastener 100, and offset downward from the first cover tab 120 and the second cover tab 132 in the longitudinal direction of the fastener 100. The third cover tab 134 engages and abuts a first base tab 140 in the longitudinal direction of the fastener 100. With this construction, the third cover tab 134 and the first base tab 140 restrict movement of the cover 104 downward in the longitudinal direction of the fastener 100 relative to the base 102, beyond the assembled position with the base 102. More specifically, the third cover tab 134 and the first base tab 140 prevent a cover bottom face 142 from moving passed a base bottom face 144 when the cover 104 is received in the base 102.

The first base tab 140 extends from the base 102 and toward the cover 104, particularly the first cover tab 120, in a lateral front-back direction of the fastener 100 perpendicular to the longitudinal direction and the left-right direction, indicated by an arrow 150. The first base tab 140 extends from a base bottom end portion 152 such that the base bottom face 144 is flat and continuous along the first base tab 140 and the base bottom end portion 152. With this construction, the base 102 may rest in the upright position with the base bottom face 144 seated on a horizontal flat surface, supported by the first base tab 140.

As depicted, the first cover tab 120 extends from a cover top end portion 154 to form the cover top face 130. Also, the third cover tab 134 extends from a cover bottom end portion 160 to form the cover bottom face 142. With this construction, the cover 104 extends in the longitudinal direction of the fastener 100 from the base top face 124 to the base bottom end portion 152 while minimizing a total length of the fastener 100 in the longitudinal direction.

The plurality of cover tabs 112 includes a fourth cover tab 162, a fifth cover tab 164, and a sixth cover tab 170 that respectively include similar features and function in a similar manner as the first cover tab 120, the second cover tab 132, and the third cover tab 134. The base 102 includes a second base tab 172 that includes similar features and functions in a similar manner as the first base tab 140 with respect to engaging the sixth cover tab 170.

In this regard, the cover 104 is symmetric in the left-right direction of the fastener 100 such that the fourth cover tab 162, the fifth cover tab 164, and the sixth cover tab 170 mirror the first cover tab 120, the second cover tab 132, and the third cover tab 134 in the left-right direction of the fastener 100. Also, the base 102 is symmetric in the left-right direction of the fastener 100 such that the second base tab 172 mirrors the first base tab 140 in the left-right direction of the fastener 100. In view of this, further description of the fourth cover tab 162, the fifth cover tab 164, the sixth cover tab 170, and the second base tab 172 is omitted for the sake of brevity.

As shown in FIG. 2, the cover 104 includes a first guide rail 174 extended in the longitudinal direction of the fastener 100 between the cover top face 130 and the cover bottom face 142. The base 102 defines channels 176, including a first channel 180 that extends from the base top face 124 to the first base tab 140 and the base bottom end portion 152. The first channel 180 receives the first guide rail 174 when the cover 104 is received by the base 102 as shown in FIG. 1.

With reference to FIG. 2, the first guide rail 174 forms a hook shape extended in the left-right direction and the front-back direction of the fastener 100. The base 102 defines the first channel 180 complementary to the hook shape of the first guide rail 174 for receiving the first guide rail 174 in the longitudinal direction of the fastener 100, and restricting movement of the first guide rail 174 in the left-right direction and the front-back direction of the fastener 100. In this manner, the first guide rail 174 and the first channel 180 restrict movement of the cover 104 relative to the base 102 in the left-right direction and the front-back direction of the fastener 100 when the cover 104 is received by the base 102 as shown in FIG. 1. In an embodiment, the first guide rail 174 is configured to snap fit the base 102 at the first channel 180 for retaining the cover 104 on the base 102 in the assembled position.

The cover 104 includes a second guide rail 182, and the channels 176 include a second channel 184. The second guide rail 182 and the second channel 184 respectively have similar features and function in a similar manner as the first guide rail 174 and the first channel 180 for retaining the cover 104 in a sliding relationship with the base 102 along the longitudinal direction, and restricting movement of the cover 104 in the front-back direction and the left-right direction of the fastener 100. In this regard, the base 102 and the cover 104 are symmetric in the left-right direction of the fastener 100 such that the second guide rail 182 and the second channel 184 mirror the first guide rail 174 and the first channel 180 in the left-right direction of the fastener. In view of this, further description of the second guide rail 182 and the second channel 184 is omitted for the sake of brevity.

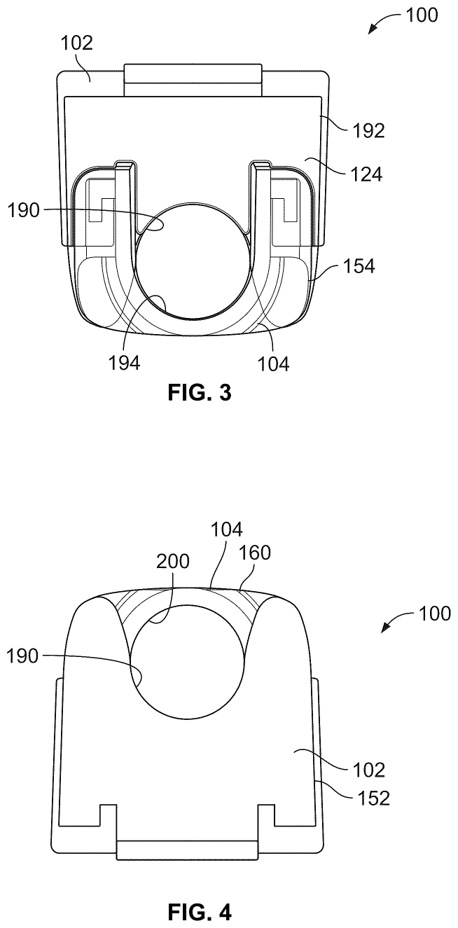

FIGS. 3 and 4 respectively depict a top view and a bottom view of the fastener 100. As shown in FIGS. 3 and 4, the base 102 and the cover 104 define a hole 190 that extends through the fastener 100 in the longitudinal direction.

In this regard, as shown in FIG. 3, the base 102 includes a base top end portion 192 that forms the base top face 124. The cover top end portion 154 and the base top end portion 192 define a top opening 194 of the hole 190. As shown in FIG. 4, the base bottom end portion 152 and the cover bottom end portion 160 define a bottom opening 200 of the hole 190. As shown from FIGS. 3 and 4, the top opening 194 and the bottom opening 200 of the hole 190 are concentric and have a same diameter in the longitudinal direction of the fastener 100. With this construction, the fastener 100 is configured to receive a cable through the hole 190 in the longitudinal direction of the fastener 100, where the cable extends through the top opening 194 and the bottom opening 200.

Referring back to FIG. 2, the fastener 100 includes a clip 202 received in the base 102. In this regard, the base 102 defines a plurality of slots 204 configured for receiving the clip 202. The clip 202 may be manually placed in any of the plurality of slots 204 by a user when the cover 104 is removed from the base 102. In an embodiment, the cover 104 may be lifted from the base 102 such that the cover 104 and the base 102 maintain contact with each other through the first guide rail 174 and the first channel 180, and maintain contact with each other through the second guide rail 182 and the second channel 184 while the clip 202 is repositioned within the slots 204.

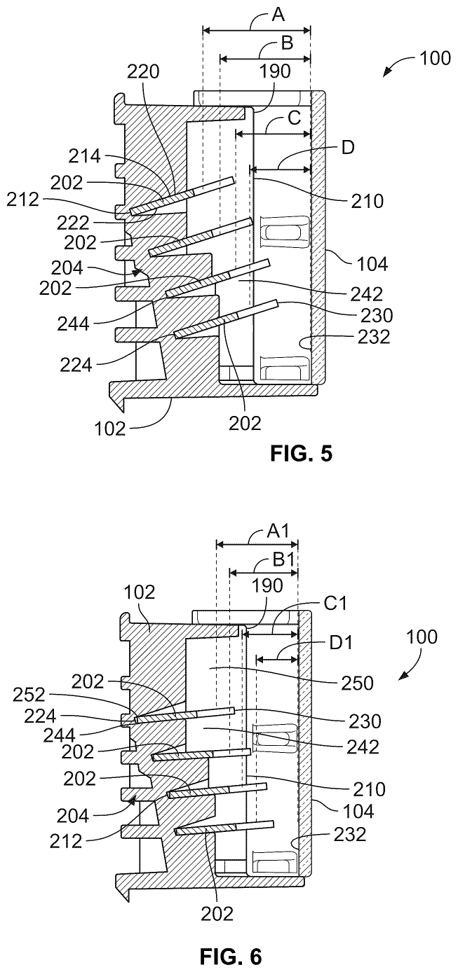

FIG. 5 depicts an example cross-sectional view of the fastener 100, with the clip 202 illustrated in each of the plurality of slots 204. As shown in FIG. 5, each of the plurality of slots 204 includes a slot opening 210, a slot end portion 212, and slot walls 214 defined by the base 102 for receiving and engaging the clip 202. The slot walls 214 of each slot 204 include a first slot wall 220 that is a top slot wall defining an upper portion of the slot 204, and a second slot wall 222 that is a bottom slot wall defining a bottom portion of the slot 204.

The clip 202 is configured for being disposed in any one of the slots 204 at a same time such that a first clip end 224 is received in the base 102, and a second clip end 230 extends outward from the first clip end 224 and the base 102 in the front-back direction of the fastener 100. Each slot end portion 212 is sized and shaped to restrict the first clip end 224 in the longitudinal direction of the fastener 100. In this regard, each slot end portion 212 has a width between the slot walls 214 that is complementary to a thickness of the first clip end 224 to engage and abut the first clip end 224 inserted in the respective slot 204, where the slot end portion 212 fixes a position of the first clip end 224 in the longitudinal direction of the fastener 100.

In an embodiment, the first clip end 224 may be configured to snap fit the slot end portions 212, such that the slot end portions 212 are each configured to fix a position of the first clip end 224 in the front-back direction and the longitudinal direction of the fastener 100. In such an embodiment, the first clip end 224 may include a protuberance (or other feature) that catches a complementary feature of the slot end portion 212 for retaining the clip 202 in the slot 204.

Each slot opening 210 is larger than the clip 202 in the longitudinal direction of the fastener 100. As such, the clip 202 defines an open space with the corresponding slot opening 210, and may pivot through the open space about the first clip end 224 between the corresponding slot walls 214. In this manner, the clip 202 is configured to pivot relative to the base 102 and the cover 104 between an unlocked position against the first slot wall 220 as depicted in FIG. 5, and a locked position against the second slot wall 222 as depicted in FIG. 6.

The slot walls 214 each respectively extend straight from the corresponding slot end portion 212 to the corresponding slot opening 210. The clip 202 is formed from a plate having flat sides that may contact and mate with the slot walls 214. As such, the corresponding slot walls 214 are configured to support the clip 202 in the corresponding slot 204 at the locked position and the unlocked position without restricting pivoting movement by the clip 202 relative to the slot opening 210.

As shown in FIGS. 5 and 6, the plurality of slots 204 are offset from each other in the longitudinal direction of the fastener 100 in regular intervals, and arranged at a variety of positions in the front-back direction. More specifically, the plurality of slots 204 are arranged farther forward in the front-back direction of the fastener 100 in descending order along the longitudinal direction. Also, an interior surface 232 of the cover 104 extends straight along the base 102 in the longitudinal direction of the fastener 100.

With this construction, the plurality of slots 204 are configured to retain the clip 202 at a variety of distances from the interior surface 232 of the cover 104, as indicated by dimensions A-D in FIG. 5, and indicated by dimensions A1-D1 in FIG. 6. Notably, dimensions A-D in FIG. 5, and dimensions A1-D1 in FIG. 6 respectively indicate a distance between center points of the second clip end 230 and the interior surface 232 of the cover 104 in the left-right direction of the fastener 100 when the clip 202 is oriented in the unlocked position and the locked position. Also, because the plurality of slots 204 are arranged farther forward in the front-back direction of the fastener 100 in descending order, dimensions A-D and A1-D1 decrease in descending order. While, as depicted, the plurality of slots 204 includes a total of four slots 204, the base 102 may define more or fewer slots for retaining the clip 202 in the unlocked position and the locked position at a variety of positions in the front-back direction of the fastener 100 without departing from the scope of the subject disclosure.

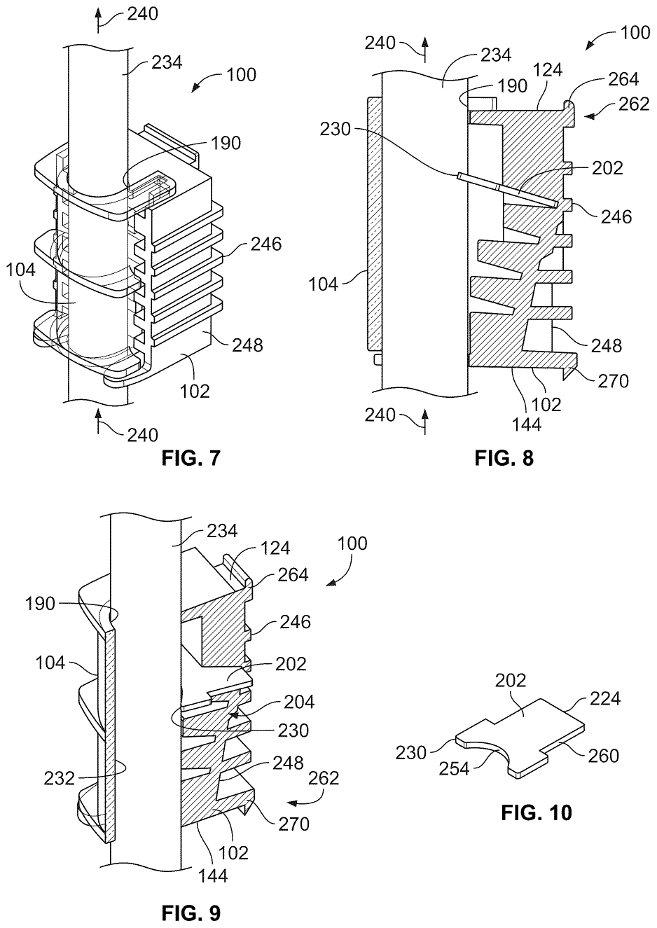

FIG. 7 depicts a cable 234 inserted through the hole 190 in the fastener 100, upward in the longitudinal direction of the fastener 100, as indicated by arrows 240. FIG. 8 depicts a cross-sectional view of the fastener 100 and the cable 234 as shown in FIG. 7, where the second clip end 230 extends from the first clip end 224, toward the cover 104, and into the hole 190 in the front-back direction of the fastener 100. As shown in FIG. 8, the clip 202 engages the cable 234 at the second clip end 230 such that when the cable 234 moves through the fastener 100 upward in the longitudinal direction of the fastener 100, the cable 234 drives the second clip end 230 upward in the longitudinal direction, pivoting the clip 202 toward the unlocked position. With this construction, the cable 234 may be pulled through the fastener 100 by a user to a predetermined location along the cable 234.

FIG. 9 depicts a cross-sectional view of the cable 234 inserted through the fastener 100, and being pulled downward in the longitudinal direction of the fastener 100. As shown in FIG. 9, contact between the cable 234 and the second clip end 230 drives the second clip end 230 downward, pivoting the clip 202 toward the locked position.

Referring back to FIGS. 5 and 6, the slot opening 210 of each slot 204 is positioned above the corresponding slot end portion 212 in the longitudinal direction of the fastener 100 such that the clip 202 is angled upwards in both the unlocked position and the locked position along the front-back direction of the fastener 100. More specifically, a lower edge 242 of each slot opening 210 is positioned above a lower edge 244 of the corresponding slot end portion 212 in the longitudinal direction of the fastener 100. Also, an upper edge 250 of each slot opening 210 is positioned above an upper edge 252 of the corresponding slot end portion 212.

In an alternative embodiment, the clip 202 is perpendicular to the longitudinal direction of the fastener 100 when in the locked position. In this regard, the lower edge 242 of each slot opening 210 is positioned at a same position as the lower edge 244 of the corresponding slot end portion 212 in the longitudinal direction of the fastener 100. With this construction, the clip 202 and the cover 104 increase a pull out load of the fastener 100 in the locked position.

As such, a distance between the second clip end 230 and the interior surface 232 of the cover 104 in the front-back direction of the fastener 100 decreases when the clip 202 pivots from the unlocked position toward the locked position. In this regard, as shown in FIGS. 5 and 6, dimensions A-D are respectively larger than the corresponding dimensions A1-D1.

With this construction, when the cable 234 moves downward in the longitudinal direction through the hole 190 in the fastener 100 and drives the clip 202 toward the locked position as shown in FIG. 9, the second clip end 230 may press into or bite the cable 234 against the interior surface 232 of the cover 104. As such, friction between the cover 104, the cable 234, and the clip 202 locks the fastener 100 with the cable 234 and prevents the cable 234 from further movement downward relative to the fastener 100 when the clip 202 is driven toward the locked position.

Notably, because the plurality of slots 204 are configured to retain the clip 202 at a variety of distances from the interior surface 232 of the cover 104, the fastener 100 may lock a variety of cables, including the cable 234, having a variety of gauge sizes. The base 102 includes ribs 246 extended outward from an exterior surface 248 of the base 102 at positions corresponding to the slots 204 along the longitudinal direction of the fastener 100. The ribs 246 form a grip feature that a user may hold to manipulate the fastener 100, and may be provided with markings or indications of gauge sizes associated with the corresponding slots 204. With this construction, a user may view the markings or indications on the ribs 246 and place the clip 202 in a corresponding slot 204 based on a predetermined size of the cable 234.

While the fastener 100 is described with respect to the cable 234, the fastener 100 may be employed to similarly receive and lock a variety of materials and objects having a variety of thicknesses and shapes, such as duct, twine, chain, thread, wire, rope, cord, line, a belt, a pole, a beam, and a bar without departing from the scope of the subject disclosure.

FIG. 10 depicts a perspective view of the clip 202. As shown in FIG. 10, the second clip end 230 forms a concave edge 254 along an outer perimeter 260 of the clip 202. The concave edge 254 formed at the second clip end 230 increases a contact surface between the second clip end 230 and the cable 234 in the fastener 100. As such, the concave edge 254 increases an amount friction generated between the second clip end 230 and the cable 234 that may be used to drive the clip 202 between the locked position and the unlocked position. While, as depicted, the second clip end 230 includes the concave edge 254, the second clip end 230 may additionally or alternatively take a variety of shapes for increasing friction between the second clip end 230 and the cable 234, such as a square edge configured to increase pressure from the clip 202 to sides of the cable 234, and a jagged edge having teeth configured to grip into the cable 234. Furthermore, while the concave edge 254 is depicted with a flat edge face along the outer perimeter 260 of the clip 202, the second clip end 230 may be sharpened along the outer perimeter 260 to press into and grip the cable 234 without departing from the scope of the subject disclosure.

In an embodiment, the fastener 100 is mounted to a supporting structure for holding and restricting movement of the cable 234 relative to the supporting structure. In this regard, with reference to FIGS. 8 and 9, the base 102 includes prongs 262 as snap features that may be pressed into and snap fit the supporting structure. The prongs 262 include a first prong 264 that is a top prong extended upward from the base top face 124, and include a second prong 270 that is a bottom prong extended downward from the base bottom face 144 in the longitudinal direction of the fastener 100.

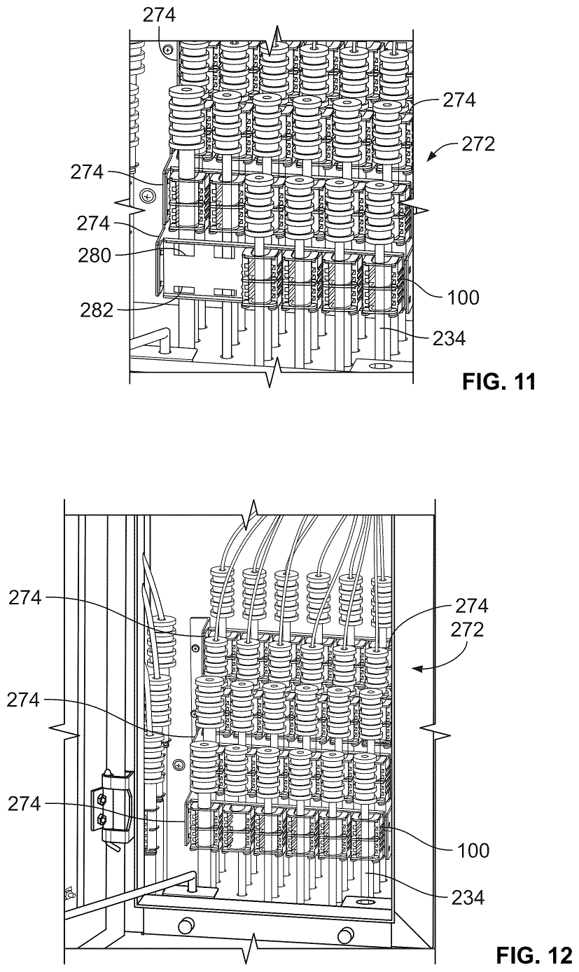

FIG. 11 depicts the fastener 100 mounted in a cabinet assembly 272, and supporting the cable 234 in the cabinet assembly 272. The cabinet assembly 272 includes support bars 274 that are supporting structures configured for receiving and supporting the fastener 100 and the cable 234 in the cabinet assembly 272. The support bars 274 each include a first hole 280 and a second hole 282 respectively configured for receiving the first prong 264 and the second prong 270 in a snap fit assembly.

While, as depicted, the fastener 100 includes the prongs 262 for snap fit assembly with the first hole 280 and the second hole 282 of the support bars 274, the support bars 274 may additionally or alternatively include prongs that snap fit features such as holes or cavities defined in the fastener 100 without departing from the scope of the subject disclosure. Furthermore, while the fastener 100 and the support bars 274 are configured to engage each other in a snap fit assembly, the fastener 100 and the support bars 274 may additionally or alternatively include a variety of features for fixing the fastener 100 with one of the support bars 274 in the cabinet assembly 272 without departing from the scope of the subject disclosure.

As shown, the cabinet assembly 272 is configured to support a plurality of fasteners and cables similar to the fastener 100 and the cable 234. FIG. 12 depicts the cabinet assembly 272 with four support bars 274 each loaded to a full capacity of six fasteners 100 and corresponding cables 234. While, as depicted, the full capacity of the cabinet assembly 272 is twenty four of the fasteners 100, the cabinet assembly may include more or fewer support bars 274 configured to hold more or fewer of the fasteners 100 each without departing from the subject disclosure.

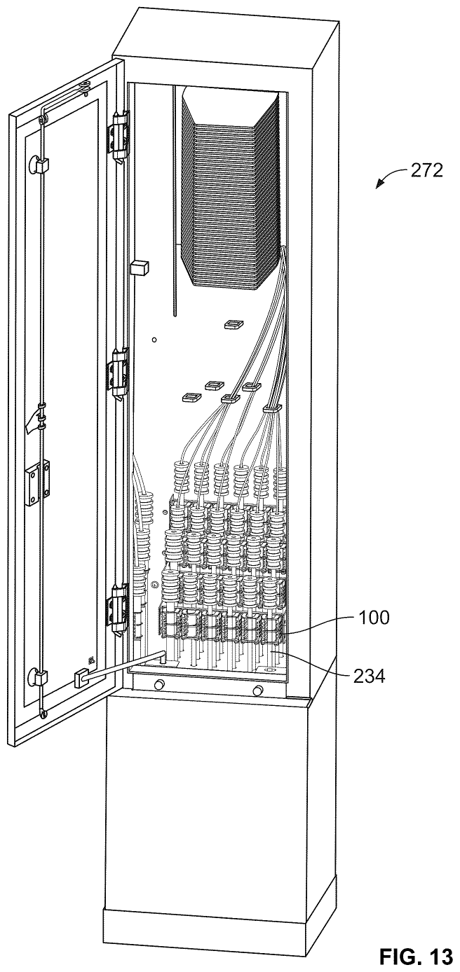

As shown in FIG. 13, the cabinet assembly 272 is a fiber optic cabinet assembly that may be part of an information technology (IT) system, and the support bars 274 support the fasteners 100 and the cables 234 at a predetermined area dedicated for cable management. Notably, while the fastener 100 is described with reference to the cabinet assembly 272 as part of an IT system, the fastener 100 may additionally or alternatively be employed in fastening a variety of materials and objects, optionally from a supporting structure, without departing from the subject disclosure.

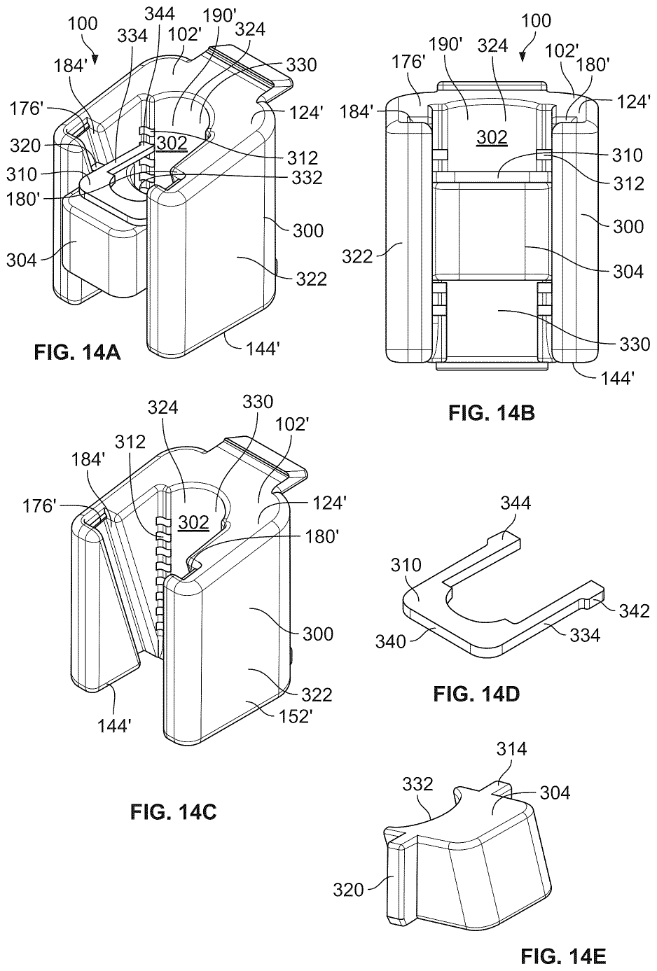

FIGS. 14A-14E illustrate an alternate embodiment of the fastener 100 of FIGS. 1-13. In the embodiment of FIGS. 14A-14E, like elements with the fastener 100 of FIGS. 1-13 are denoted with the same reference numerals but followed by a primed suffix (′). FIGS. 14A-14E depict an embodiment of the fastener 100 where the base 102′ includes inner base walls 300 which define an interior 302 of the base 102′ that receives a wedge 304 and a clamp 310. The inner base walls 300, the wedge 304, and the clamp 310 lock the cable 234 with the fastener 100 when the cable 234 is inserted through the hole 190′.

As shown in FIG. 14A, the inner base walls 300 define the channels 176′ extended linearly at an angle offset from vertical, and more specifically offset from the top-bottom direction in the front-back direction. The channels 176′ extend through the base 102′, from the base top face 124′ to the base bottom face 144′. With this construction, the wedge 304 may slide through the base 102′ from the base top face 124′ to the base bottom face 144′, while reducing a distance between the wedge 304 and one of the inner base walls 300 opposite the wedge in the front-back direction, closing the interior 302.

In this regard, the channels 176′ are sloped from a front portion of the base top face 124′ toward a back portion of the base bottom face 144′ with respect to the front-back direction. As shown in FIG. 14B, the inner base walls 300 define detents 312 arranged in the top-bottom direction, at opposite sides of the base 102′ in the left right direction. The detents 312 are recesses with top and bottom walls that extend into the base 102′ in the front-back direction, and catch the clamp 310, obstructing the wedge 304 from upward motion in the top-bottom direction.

As shown in FIG. 14E, the wedge 304 has a first flange 314 and a second flange 320 extended opposite from each other, straight in the left-right direction. With the fastener 100 assembled as shown in FIG. 14B, the first flange 314 and the second flange 320 are respectively aligned with and received in the first channel 180′ and the second channel 184′. The first flange 314 and the second flange 320 are guide runners that slide along the channels 176′, at the angle between the top-bottom direction and the front-back direction, defined by the inner base walls 300.

The base 102′ includes a pair of base side walls 322 that extend from a base back wall 324 in the front-back direction. The base side walls 322 define the channels 176′ and are integrally formed with the base back wall 324. The base back wall 324 extends between and spaces the base side walls 322 in the left-right direction, connecting and supporting the base side walls 322. The base back wall 324 forms an inner back wall surface 330 that is concave and faces the wedge in the front-back direction. With this construction, a force applied by a user to the wedge 304 in the top-bottom direction may cause the first flange 314 and the second flange 320 to run or slide within the channels 176′, guiding the wedge 304 toward or away from the inner back wall surface 330.

As shown in FIG. 14A, the wedge 304 includes a wedge back surface 332 that is concave and faces the inner back wall surface 330 in the front-back direction. As such, when the wedge 304 is driven downward through the base 102′, along the channels 176′, the wedge back surface 332 is driven toward the inner back wall surface 330 in the front-back direction, closing the interior 302 of the base 102′. In this manner, the wedge 304 may be driven to slide along the channels 176′ and clamp a cable, such as the cable 234, between the wedge back surface 332 and the base back wall 324 at the inner back wall surface 330. The concave profiles of the inner back wall surface 330 and the wedge back surface 332 increase an overall surface area that contacts a cable, such as the cable 234, inserted through the hole 190′, increasing an amount of friction between the cable and the fastener 100, increasing a locking force of the fastener 100 on the cable.

As shown in FIG. 14C, the channels 176′ extend from the base top face 124′ to the base bottom face 144′, and the channels 176′ open up at the base bottom face 144′. With this construction, the wedge 304′ may be pressed through the base 102′ upwards or downwards in the top-bottom direction, preventing the wedge 304′ from becoming stuck in the base 102′. Alternatively, the channels 176′ may end at the base bottom end portion 152′ before the base bottom face 144′. With this construction, the base bottom end portion 152′ supports the base 102′ in the fastener 100 at the base bottom face 144′.

As shown in FIG. 14D, the clamp 310 includes a pair of prongs 334 that extend from a frame portion 340 in the front-back direction. The prongs 334 are integrally formed with the frame portion 340, and bend inward with the frame portion 340 in the left-right direction when inserted into the interior 302 of the base 102′. The frame portion 340 extends between and spaces the prongs 334 in the left-right direction, such that the prongs 334 extend around and avoid obstruction with a cable, such as the cable 234, inserted through the hole 190′.

The clamp 310 includes a first ridge 342 and a second ridge 344 extended outward from distal end portions 350 of the prongs 334 in the left-right direction. More specifically, the first ridge 342 and the second ridge 344 respectively protrude in opposite directions from opposite sides of the prongs 334 in the left-right direction.

As shown in FIG. 14A, when the wedge 304 is assembled with the base 102′, the fastener 100 defines the hole 190′ extended along the top-bottom direction from the base top face 124′ to the base bottom face 144′. With this construction, the fastener 100 may receive a cable, such as the 234 through the hole 190′ in the top-bottom direction.

The clamp 310 is placed flatly on top of the wedge 304, and pushed toward the base back wall 324, where the first ridge 342 and the second ridge 344 are snap-fit within the detents 312. As such, the clamp 310 is locked on top of the wedge 304 in the base 102′, obstructing the wedge 304 from moving upward in the interior 302 of the base 102′, toward the base top face 124′.

When the cable 234 is inserted through the hole 190′ and the wedge 304 is driven downward through the base 102′, along the channels 176′, the wedge 304 is driven toward the base back wall 324 and clamps the cable 234 between the wedge back surface 332 and the inner back wall surface 330. As such, the wedge 304 is obstructed by the cable 234 and the base 102′ from moving further downward in the top-bottom direction. With the clamp 310 placed on top of the wedge 304 and snap-fit in the detents 312, the base 102′, the cable 234, and the clamp 310 obstruct the wedge 304 from moving upward toward the base top face 124′, and the cable 234 prevents the wedge 304 from moving downward toward the base bottom face 144′. In this manner, the cable 234 may be clamped by the fastener 100, where the wedge 304 and the cable 234 are locked with the base 102′.

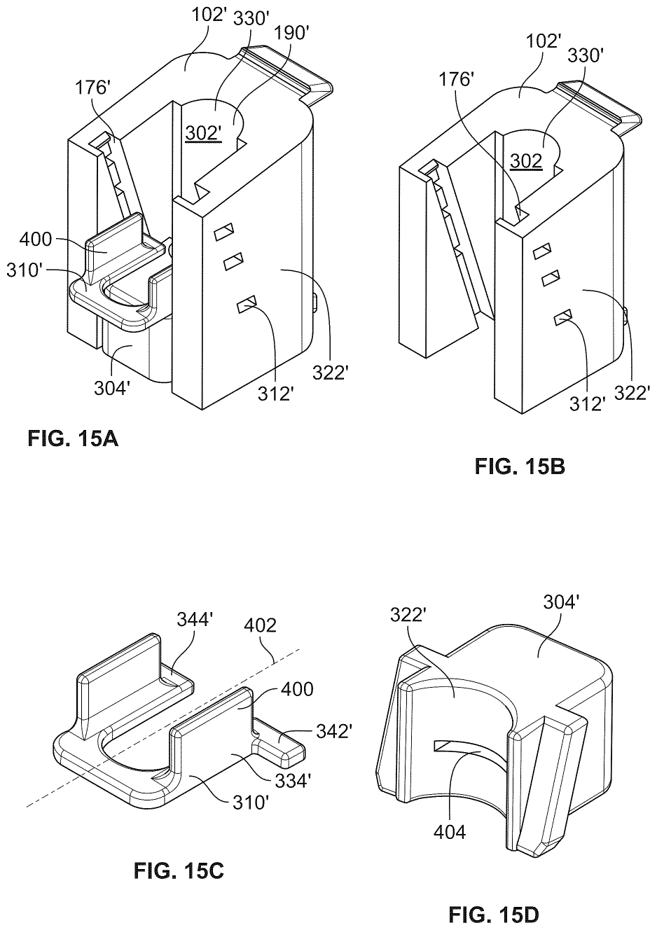

FIGS. 15A-15D illustrate an alternate embodiment of the fastener 100 of FIGS. 1-14E. In the embodiment of FIGS. 15A-15D, like elements with the fastener 100 of FIGS. 1-14E are denoted with the same reference numerals but followed by a primed suffix (′).

As shown in FIGS. 15A and 15B, the base side walls 322′ define the detents 312′ in the channels 176′. The detents 312′ catch and lock the clamp 310′ with the base 102′ as shown in FIG. 15A, obstructing upward movement of the wedge 304′ in the top-bottom direction relative to the base 102′. The clamp 310′ has a pair of fins 400 that each extend upward from one of the prongs 334′. A user may manually press the fins 400 inward in the left-right direction, manipulating the prongs 334′, the first ridge 342′, and the second ridge 344′.

More specifically, as shown in FIG. 15C, the fins 400 may be pressed toward a lateral middle line 402 of the clamp 310′ extended in the front-back direction. With this construction, when the clamp 310′ is assembled with the base 102′ as shown in FIG. 15A, a user may squeeze the fins 400 in the left-right direction and disengage the first ridge 342′ and the second ridge 344′ from the detents 312′. A user may also squeeze the fin 400 to insert the clamp 310′ into the interior 302′ as shown in FIG. 15A, where the clamp 310′ takes an interference fit against the base side walls 322′ as the clamp 310′ is pressed to the base back wall 324′, where the first ridge 342′ and the second ridge 344′ snap-fit the detents 312′. In this manner, the clamp 310′ may engage or disengage the first ridge 342′ and the second ridge 344′ with the detents 312′, as facilitated by manipulating the fins 400. As such, the clamp 310′ obstructs the wedge 304′ from moving upward in the top-bottom direction, toward the base top face 124′ when the first ridge 342′ and the second ridge 344′ are engaged with the detents 312′.

The first ridge 342′ and the second ridge 344′ fit within, and may slide along the channels 176′ until engaged with the detents 312′. With this construction, the clamp 310′ may be inserted into the interior 302′ of the base 102′, where the clamp 310′ slides with the wedge 304′ along the channels 176′ until interlocking with the detents 312′.

As depicted, the detents 312′ are through holes that extend in the left-right direction. With this construction, the first ridge 342′ and the second ridge 344′ may extend entirely through the base side walls 322′ when interlocked with the detents 312′. As such, the clamp 310′ may fully utilize structural support available from the base 102′ in obstructing the wedge 304′ from moving upward in the top-bottom direction, reducing an overall thickness of the base side walls 322′, the first ridge 342′ and the second ridge 344′ required for adequate support in locking a cable, such as the cable 234.

FIG. 15D depicts the wedge 304′ defining a passage 404 in the wedge back surface 332′. The passage 404 may hold the clip 202′ shown in FIG. 10 to face the inner back wall surface 330′ of the base 102′. With reference to FIG. 15D, with the clip 202′ inserted in the passage 404, the clip 202′ is configured to engage a cable, such as the cable 234, inserted through the hole 190′. In this regard, the clip 202′ includes the concave edge 254′ configured to protrude from the wedge back surface 332′, and engage a cable in the front-back direction ahead of the wedge back surface 332′. The concave edge 254′ is relatively sharp as compared to the wedge back surface 332′, and increases a gripping force of the wedge 304′ against a cable, such as the cable 234, in a concentrated area.

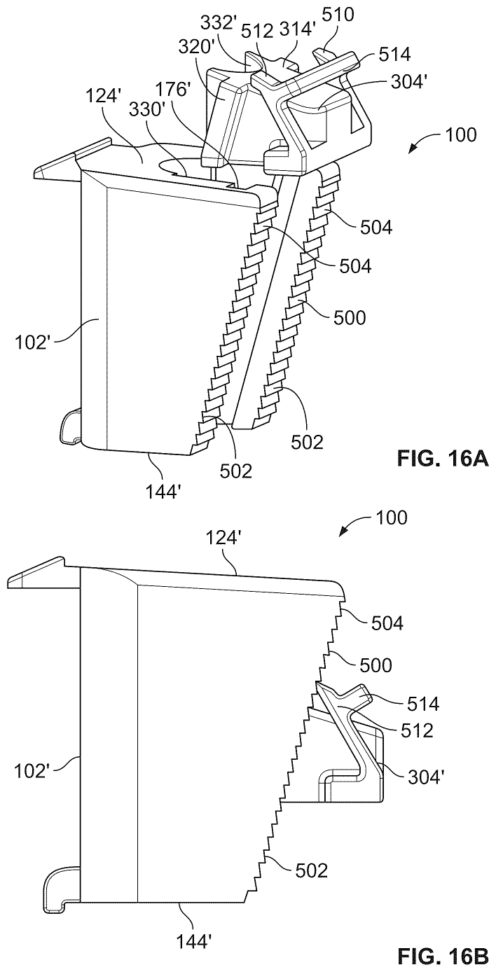

FIGS. 16A and 16B illustrate an alternate embodiment of the fastener 100 of FIGS. 1-15D. In the embodiment of FIGS. 16A and 16B, like elements with the fastener 100 of FIGS. 1-15D are denoted with the same reference numerals but followed by a primed suffix (′).

As shown in FIGS. 16A and 16B, the base 102′ includes a plurality of base teeth 500 formed along distal ends 502 of the base side walls 322′ that face forward in the front-back direction. The base teeth 500 are oriented forward from the distal ends 502 in the front-back direction, and are arranged in base tracks 504 that run along the base 102′ in the top-bottom direction, at an angle parallel with the channels 176′. The base tracks 504 and the channels 176′ extend entirely along the base 102′ in the top-bottom direction, from the base top face 124′ to the base bottom face 144′.

Each tooth among the base teeth 500 forms an edge that runs in the left-right direction, and is angled downward in the top-bottom direction. As shown in FIG. 16A, the wedge 304′ includes a first pawl 510 and a second pawl 512 that catch and mate with the base teeth 500 at opposite sides of the base 102′ in the left-right direction. In this regard, the channels 176′ and the base tracks 504 are parallel with each other, and spaced from each other such that the channels 176′ may receive the first flange 314′ and the second flange 320′ while the first pawl 510 and the second pawl 512.

When the first pawl 510 and the second pawl 512 are mated with the base teeth 500 as shown in FIG. 16B, the first pawl 510 and the second pawl 512 obstruct movement of the wedge 304′ upward in the top-bottom direction, along the base tracks 504 and the channels 176′. With this construction, the fastener 100 is configured to lock a cable, such as the cable 234, between the wedge 304′ and the base 102′, where the first pawl 510 and the second pawl 512 prevent movement of the wedge 304′ upward, the cable obstructs movement of the wedge 304′ downward along the channels 176′. Also, friction between the inner back wall surface 330′ and the cable, and friction between the wedge back surface 332′ locks the cable with the fastener 100, holding the cable from moving in the top-bottom direction.

Referring back to FIG. 16A, the wedge 304′ includes a handle 514 extended between and connecting the first pawl 510 and the second pawl 512 in the left-right direction. The handle 514 is integrally formed with the first pawl 510 and the second pawl 512, and may be pulled forward from the base 102′, causing the first pawl 510 and the second pawl 512 to flex. In this manner, a user may pull the first pawl 510 and the second pawl 512 forward from the base 102′ relative to the first flange 314′ and the second flange 320′ via the handle 514, disengaging the first pawl 510 and the second pawl 512 from the base tracks 504 and unlocking the wedge 304′ from the base 102′. With the wedge 304′ unlocked from the base 102′, the wedge 304′ may be lifted and removed from the base 102′ and a cable in the fastener, such as the cable 234, unlocking the cable from the fastener 100.

While, as depicted, the base tracks 504 include two tracks corresponding to the first pawl 510 and the second pawl 512, the base 102′ may alternatively include more or fewer tracks that correspond with more or fewer pawls that obstruct upward movement of the wedge 304′ along the channels 176′ without departing from the scope of the subject disclosure.

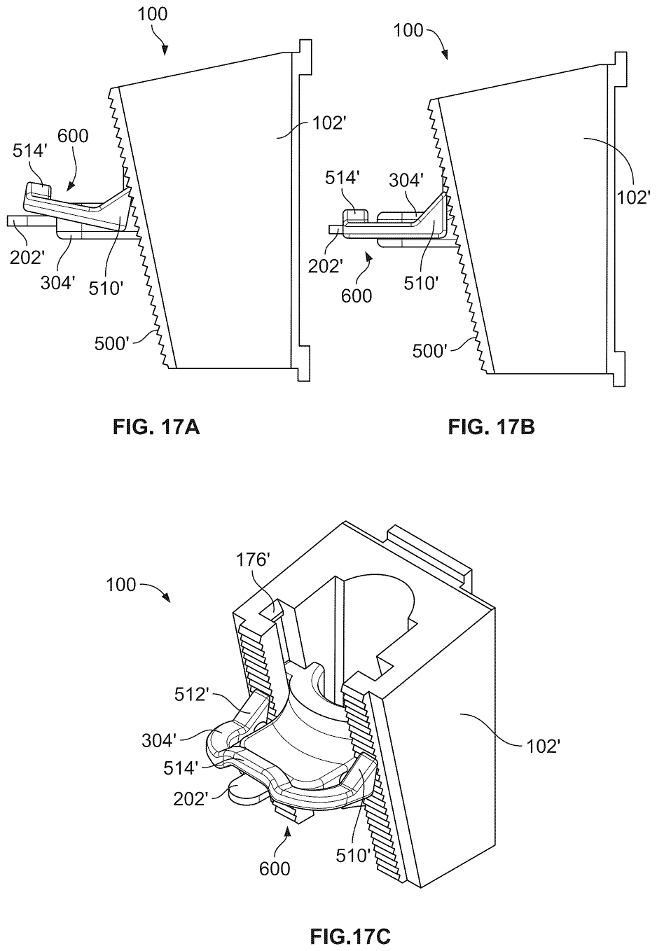

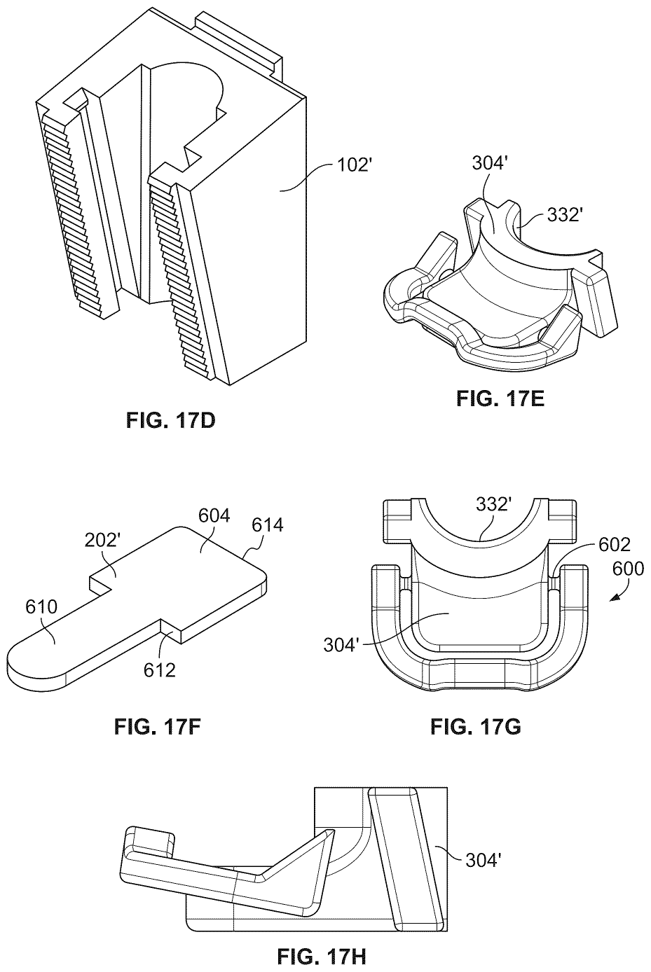

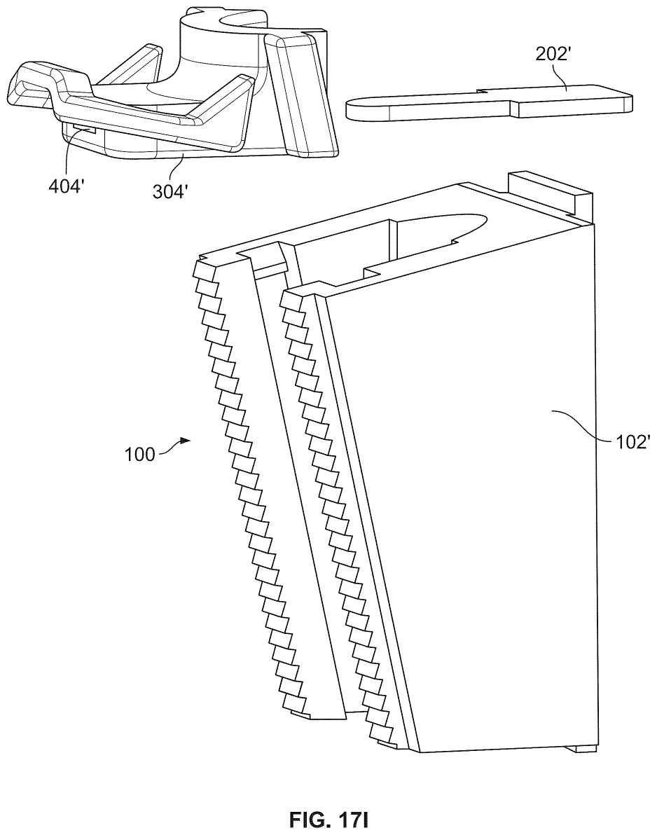

FIGS. 17A-17I illustrate an alternate embodiment of the fastener 100 of FIGS. 1-16B. In the embodiment of FIGS. 17A-17I, like elements with the fastener 100 of FIGS. 1-16B are denoted with the same reference numerals but followed by a primed suffix (′).

As shown in 17C, the first pawl 510′, the second pawl 512′, and the handle 514′ form a brake module 600 that interlocks with the clip 202′ and the base 102′, obstructing movement of the wedge 304′ upward along the channels 176′. In this regard, as shown in FIG. 17G, the brake module 600 is fixed with opposite sides of the wedge 304′ across hinges 602 in the left-right direction.

The hinges 602 are live hinges that flex and allow the brake module 600 to rotate relative to the wedge 304′ about the left-right direction. The hinges 602 elastically resist the brake module 600 rotating relative to the wedge 304′, biasing the first pawl 510′ and the second pawl 512′ toward a locked position with the base teeth 500, as shown in FIG. 17A. In the locked position, the first pawl 510′ and the second pawl 512′ are interlocked with the base teeth 500′ and obstruct motion of the wedge 304′ upward along the channels 176′.

With reference to FIG. 17I, the passage 404′ is a through hole that extends through the wedge 304′ in the front-back direction. The passage 404′ receives the clip 202′ forward in the front-back direction, where the clip 202′ extends beyond the wedge back surface 332′ in the front-back direction, and is configured to contact a cable, such as the cable 234, inserted through the hole 190′.

The clip 202′ may slide against the wedge 304′, within the passage 404′ in the front-back direction. As shown in FIG. 17F, the clip 202′ includes a blade 604 and a tongue 610 integrally formed with the blade 604. The blade 604 and the tongue 610 extend flatly from each other in the front-back direction. The blade 604 is wider than the tongue 610 in the left-right direction, forming shoulders 612 where the blade 604 extends from the tongue 610.

The shoulders 612 are wider than a narrowed portion of the passage 404′ inside the wedge 304′, in the left-right direction. With this construction, when the clip 202′ is inserted forward in the passage 404′ and has reached a predetermined location in the wedge 304′, the shoulders 612 obstruct further movement of the clip 202′ forward in the front-back direction. As such, when the clip 202′ is driven against a cable, such as the cable 234, in the fastener 100, the clip 202′ remains at the predetermined location and presses a flat edge 614 of the blade 604 into the cable, as supported by the narrowed portion of the passage 404′ at the shoulders 612.

FIG. 17B depicts the brake module 600 in an unlocked position with respect to the base 102′. In this regard, the handle 514′ may be pressed downward in the top-bottom direction, reorienting the first pawl 510′ and the second pawl 512′ out of engagement with the base teeth 500′. In this manner, a user may press downward on the handle 514′ and disengage the first pawl 510′ and the second pawl 512′ from the base teeth 500′, allowing the wedge 304′ to move upward along the channels 176′.

Referring back to FIG. 17F, the flat edge 614 is sharper than the wedge back surface 332′. With this construction, the clip 202′ may engage a cable, such as the cable 234, in the fastener 100 with relatively increased grip or bite force in a concentrated area of the cable as compared to the wedge back surface 332′ alone.

The clip 202′ is removable from the wedge 304′, and may slide out from the passage 404′ backward in the front-back direction. More specifically, a user my press the tongue 610 backward in the front-back direction, causing the tongue 610 to slide from the passage 404′ and out of the wedge 304′. With this construction, users employing the fastener 100 may optionally include the clip 202′ with the wedge 304′ by inserting the clip 202′ forward in the passage 404′ before driving the wedge 304′ into the interior 302′ of the base 102′. In this regard, the wedge back surface 332′ may contact a cable in the fastener 100 without the relatively concentrated grip or bite force, avoiding tearing or otherwise damaging an outer element of the cable, such as a sleeve, a cover, a sheath, a jacket, a conduit, insulation, wrapping, or tubing.

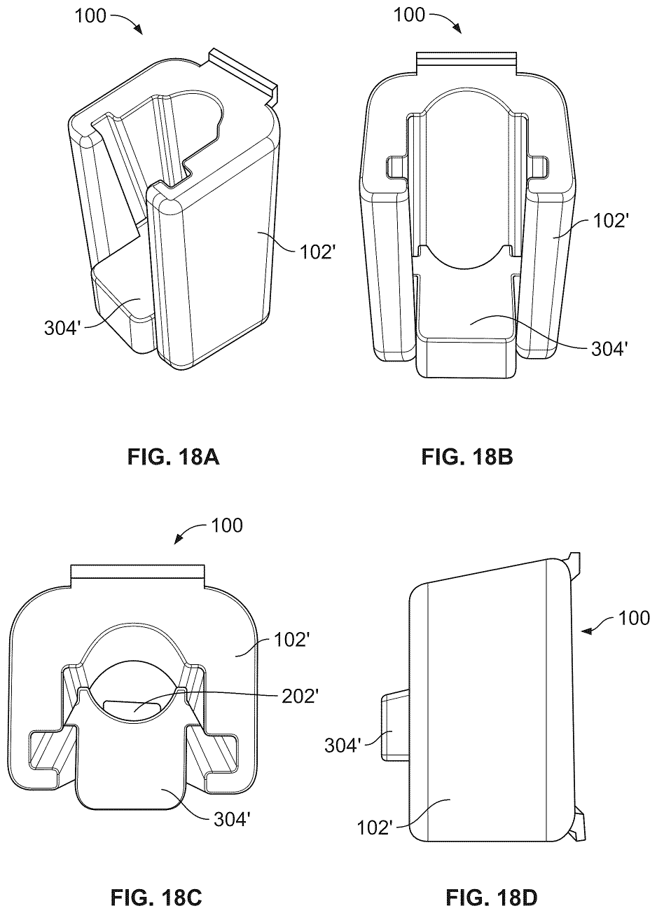

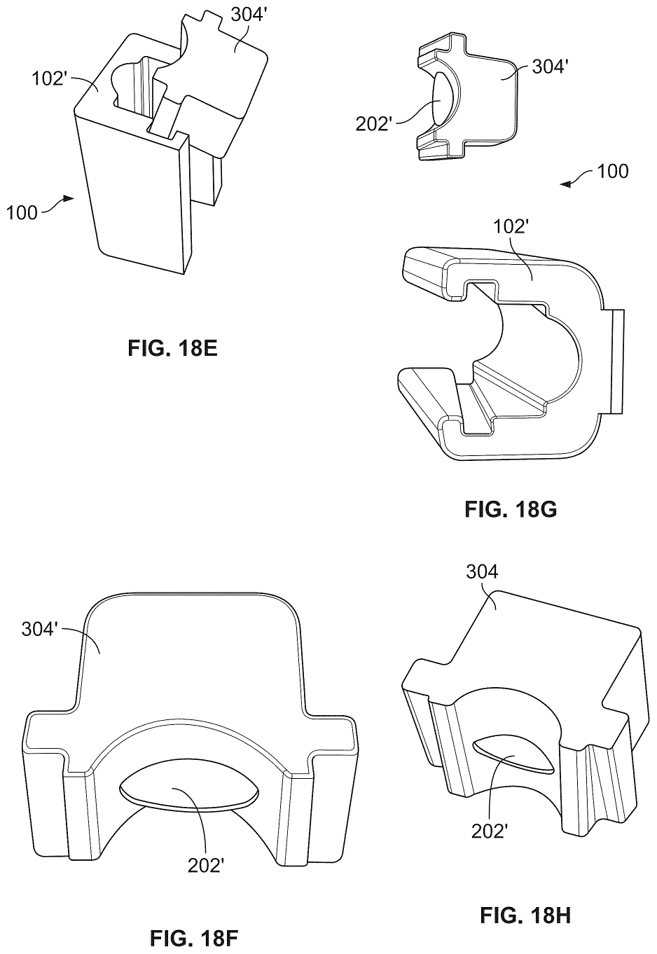

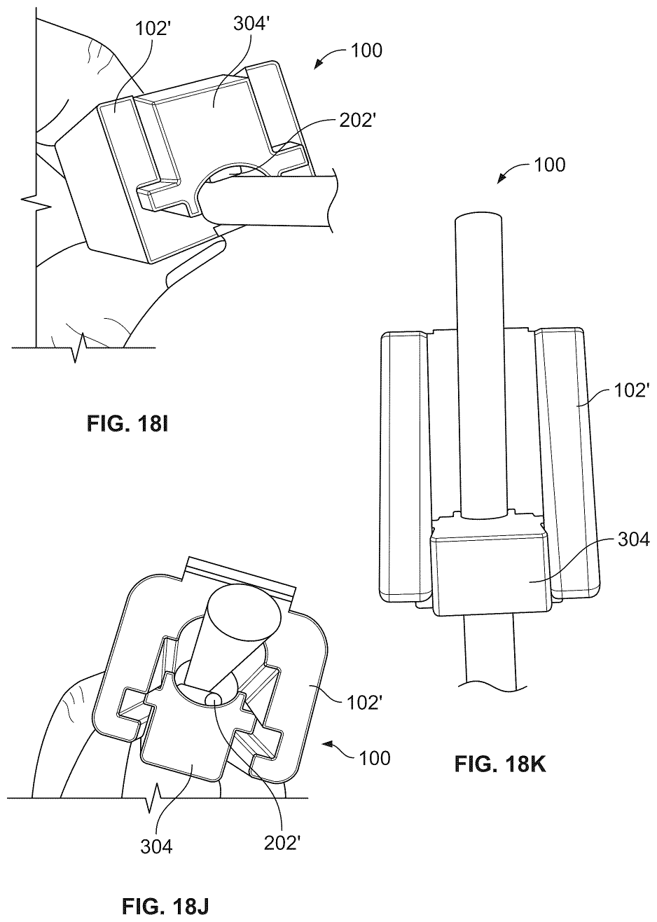

FIGS. 18A-18K illustrate an alternate embodiment of the fastener 100 of FIGS. 1-17I. In the embodiment of FIGS. 18A-18K, like elements with the fastener 100 of FIGS. 1-17I are denoted with the same reference numerals but followed by a primed suffix (′).

As shown in FIGS. 18A-18K, the base 102′ and the wedge 304′ are formed from a 3D printed Acrylonitrile Butadiene Styrene (ABS) filament. While, as depicted, the base 102′ and the wedge 304′ are formed from 3D printed ABS plastic, the base 102′ and the wedge 304′ may additionally or alternatively be formed with a variety of rigid materials in a variety of manners for locking a cable in the fastener 100, optionally with the clip 202′ provided in the wedge 304′ without departing from the scope of the subject disclosure. Also, while as depicted in FIG. 18C, the clip 202′ is formed from a pressed or cut metal plate, the clip 202′ may additionally or alternatively be formed from a variety of rigid materials in a variety of manners for insertion in the passage 404′ and engagement with a cable without departing from the scope of the subject disclosure.

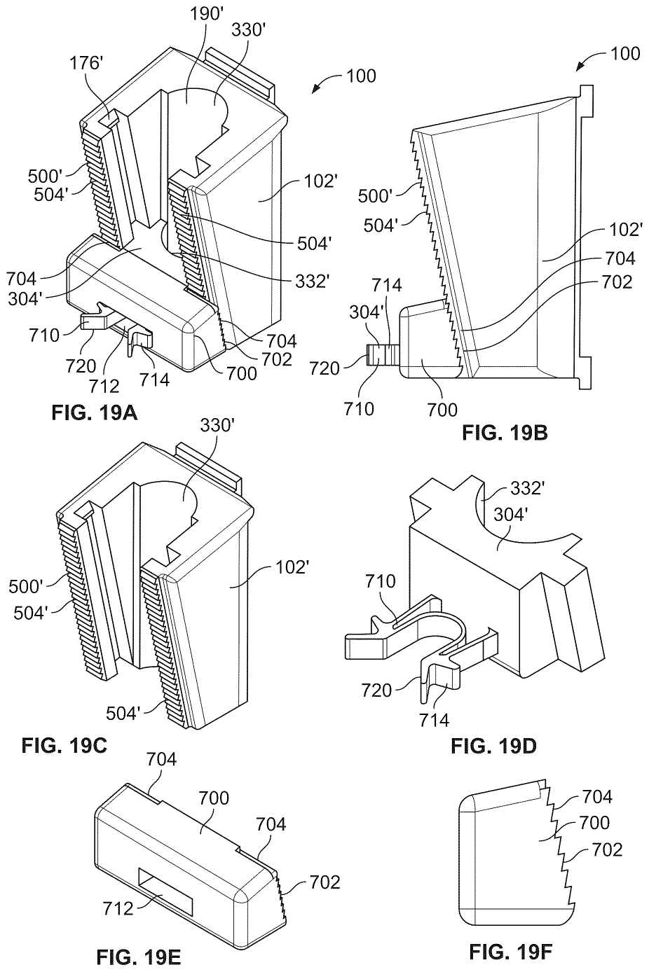

FIGS. 19A-19F illustrate an alternate embodiment of the fastener 100 of FIGS. 1-18K. In the embodiment of FIGS. 19A-19F, like elements with the fastener 100 of FIGS. 1-18K are denoted with the same reference numerals but followed by a primed suffix (′).

As shown in FIG. 19A, the fastener 100 includes a cap 700 removably fixed with the wedge 304′ and interlocked with the base teeth 500′. In this regard, as shown in FIG. 19F, the cap 700 includes cap teeth 702 extended backward in the front-back direction, and configured to mate with the base teeth 500′ extended from the base 102′. As shown in FIG. 19E, the cap 700 includes the cap teeth 702 arranged along cap tracks 704 that run along the cap 700 in the top-bottom direction, at an angle parallel with the base tracks 504′. The cap tracks 704 are located at opposite sides of the cap 700 in the left-right direction, and extend entirely along the cap 700 in the top-bottom direction. Referring back to FIG. 19F, each tooth among the cap teeth 702 forms an edge that runs in the left-right direction, and is angled upward in the top-bottom direction. With this construction, the cap tracks 704 may engage and slide downward along the base tracks 504′ as shown in FIG. 19A.

With reference to FIG. 19B, as the cap tracks 704 slide downward along the base tracks 504, the cap teeth 702 catch and mate with the base teeth 500 at opposite sides of the base 102′ in the left-right direction, obstructing upward motion of the cap 700 along the base tracks 504′. In this manner, the cap 700 is removably fixed with the wedge 304′, and restricts movement by the wedge 304′ along the channels 176′ when fixed to the wedge 304′.

With this construction, the fastener 100 is configured to lock a cable, such as the cable 234, between the wedge 304′ and the base 102′, where the cap 700 prevents movement of the wedge 304′ upward along the channels 176′, the cable obstructs movement of the wedge 304′ downward along the channels 176′. Also, friction between the inner back wall surface 330′ and the cable, and friction between the wedge back surface 332′ locks the cable with the fastener 100, holding the cable from moving in the top-bottom direction.

Referring back to FIG. 19A, the cap 700 is removably fixed to the wedge 304′ by fingers 710 extended through an aperture 712 defined in the cap 700. In this regard, as shown in FIG. 19D, the wedge 304′ includes the fingers 710 extended forward in the front-back direction. Each of the fingers 710 includes a hook 714 extended outward in the left-right direction, and a finger tab 720 extended beyond the hook 714, forward in the front-back direction.

The fingers 710 are integrally formed with the wedge 304′, and formed from a material that flexes in response to manipulation by a user. As such, a user may press the fingers 710 inward in the left-right direction at the finger tabs 720, causing the hooks 714 to recede inward with the fingers 710.

As shown in FIG. 19A, the fingers 710 extend through the cap 700, to a side of the cap 700 opposite the base 102′ in the front back direction. The hooks 714 extend away from the aperture 712 in the left-right direction, along the side of the cap 700 opposite the base 102′, obstructing movement of the cap 700 away from the base 102′ in the front-back direction. In this manner, the fingers 710 lock the wedge 304′ with the cap 700.

A user may squeeze the fingers 710 inward, toward a center of the aperture 712 in the left-right direction, causing the fingers 710, including the hooks 714, to recede inward, within a cross-sectional area of the aperture 712 taken in the front-back direction. As such, the fingers 710 squeezed inward no longer obstruct movement of the cap 700 away from the wedge 304′, and the user may remove the cap 700 from the wedge 304′ forward in the front-back direction.

In this manner, the fingers 710 removably fix the cap 700 with the wedge 304′. When the cap 700 is removed from the wedge 304′ the wedge 304′ is unobstructed from upward movement along the channels 176′, and may be removed from the base 102′, including when a cable is inserted through the hole 190′.

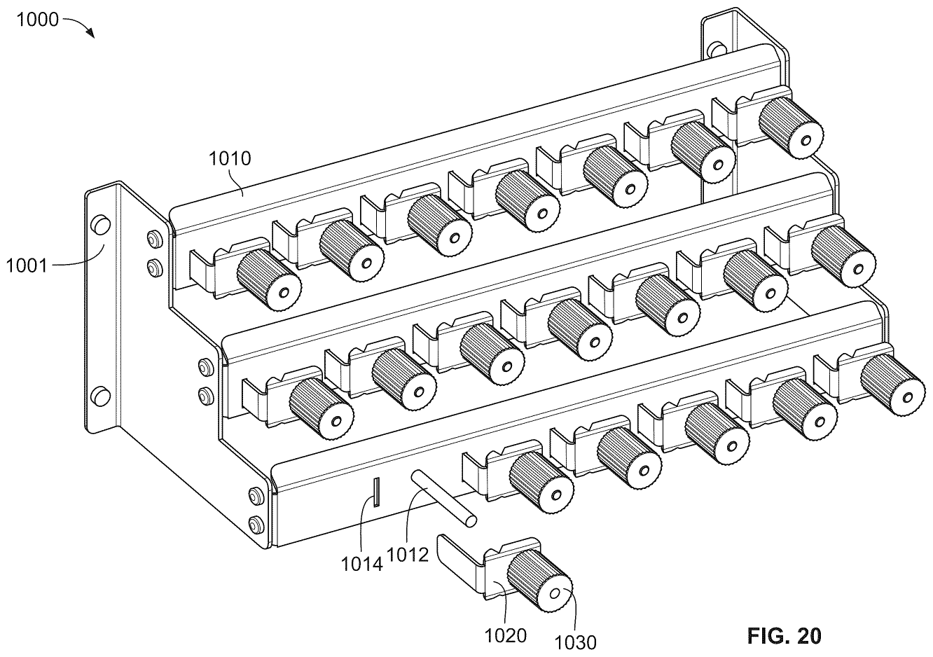

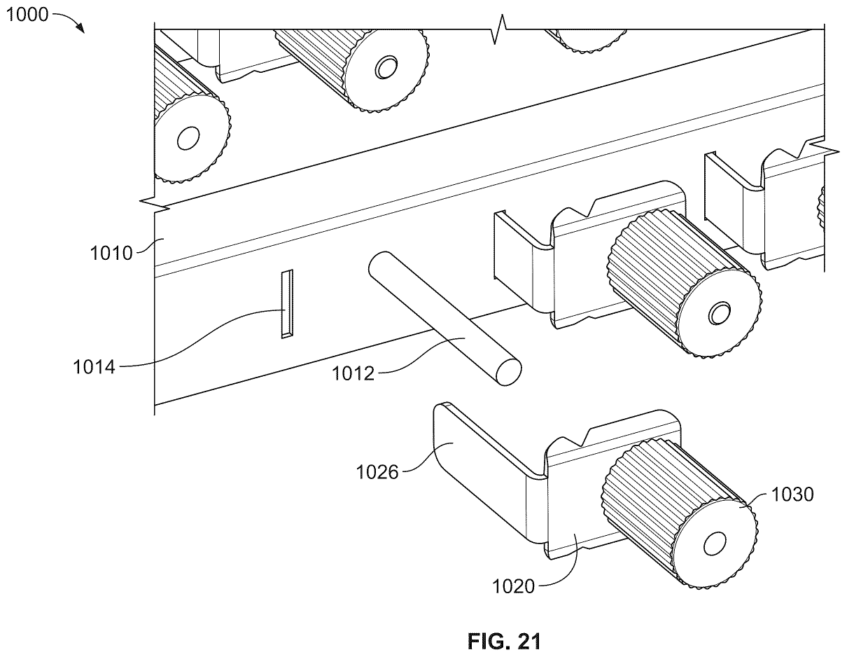

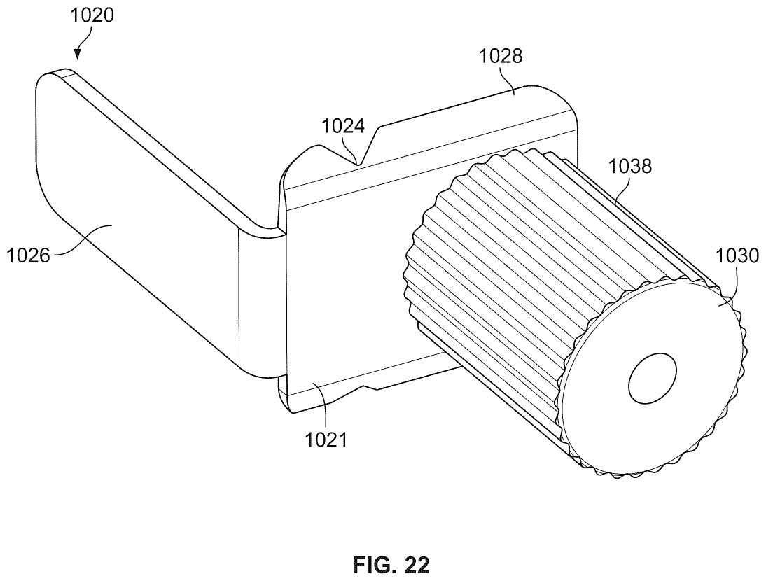

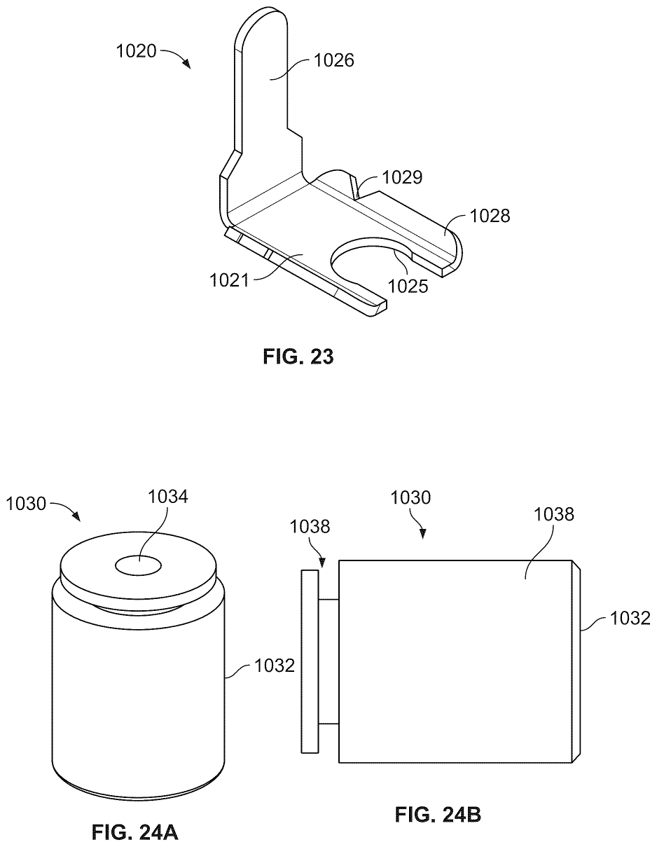

Referring to FIGS. 20-27, in some embodiments the fastener system 1000 for cable management comprises a linear drive mechanism configured to provide infinitely adjustable clamping force within a predetermined range, rather than discrete slot positions or ratcheting mechanisms as described in connection with the previous embodiments. The linear drive mechanism converts an input motion into linear displacement of a retention clip toward or away from a support structure to clamp or release a cable or duct. In some embodiments, the linear drive mechanism comprises a threaded clamping mechanism, as described in detail below. In other embodiments, the linear drive mechanism may comprise a rack and pinion mechanism, a lead screw mechanism, a cam mechanism, or other suitable mechanism for converting rotational or other input motion into linear motion.

Referring now to FIG. 20, in embodiments where the linear drive mechanism comprises a threaded clamping mechanism, the fastener system 1000 includes a support structure 1001 comprising a support strap 1010, a retention clip 1020, and a threaded nut 1030. The threaded nut 1030 and a corresponding threaded stud 1012 together form the linear drive mechanism in this embodiment. The support strap 1010 is configured to be mounted to a support structure such as a module rack, interior panel, cabinet assembly, or enclosure. In some embodiments, the support strap 1010 can be directly mounted to a wall or a work surface.

The support strap 1010 defines a slot 1014 configured to receive a support portion 1026 of the retention clip 1020. The slot 1014 maintains the retention clip 1020 in a predetermined orientation relative to the support strap 1010 and the threaded stud 1012. In some embodiments, the support strap 1010 includes bent edges 1016 extending along lateral sides of the support strap 1010. The bent edges 1016 increase the stiffness of the support strap 1010 and reduce bending when forces are imposed by a cable or duct being compressed against the support strap 1010. In some embodiments, the support strap 1010 is formed from bent sheet metal. In other embodiments, the support strap 1010 is formed from injection-molded plastic to reduce cost and assembly time.

Referring now to FIGS. 21-24, the retention clip 1020 includes a body 1021 and the support portion 1026 configured to be disposed in the slot 1014 of the support strap 1010 and a second end extending away from the support strap 1010 toward a cable or duct to be retained. In some embodiments, the retention clip 1020 includes a support portion 1026 at or near the first end that serves as a guide to control the orientation of the retention clip 1020 within the slot 1014.

The retention clip 1020 further includes bent edges 1028 extending along lateral sides of the retention clip 1020. The bent edges 1028 provide additional stiffness to the retention clip 1020, which in turn provides additional biting force when the retention clip 1020 is compressed against a cable or duct. In some embodiments, the retention clip 1020 includes one or more tooth features 1029 configured to compress against and grip the cable or duct. The tooth features 1029 may comprise ridges, serrations, or other surface texture configured to increase friction between the retention clip 1020 and the cable or duct.

The retention clip 1020 defines a clip slot 1025 configured to engage with the threaded nut 1030. The clip slot 1025 has a shape that permits the threaded nut 1030 to be assembled onto the retention clip 1020 while allowing the threaded nut 1030 to rotate freely relative to the retention clip 1020 after assembly. In some embodiments, a width of the clip slot 1025 is slightly larger than a thickness of the material forming the retention clip 1020 to permit free rotation of the threaded nut 1030.

In one embodiment of the linear drive mechanism, the threaded nut 1030 includes a body 1032 having a generally cylindrical shape, a threaded hole 1034 extending through a center of the body 1032, and a groove 1036 formed in an exterior surface of the body 1032. The groove 1036 is configured to engage with the clip slot 1025 of the retention clip 1020 to create a clip-nut assembly. The threaded hole 1034 is configured to threadably engage with the threaded stud 1012 of the support strap 1010.

In some embodiments, the body 1032 includes an external surface geometry 1038 configured to provide an installer with additional grip when tightening or loosening the threaded nut 1030. The external surface geometry 1038 may comprise knurling, flats, ridges, a knob, wings, a lever, or other tactile features that facilitate manual rotation of the threaded nut 1030. In some embodiments, the external surface geometry 1038 comprises a knob extending radially from the body 1032. The threaded nut 1030 may be formed from metal, injection-molded plastic, or injection-molded plastic with a metallic threaded insert disposed in the threaded hole 1034 to reduce manufacturing cost while maintaining thread durability.

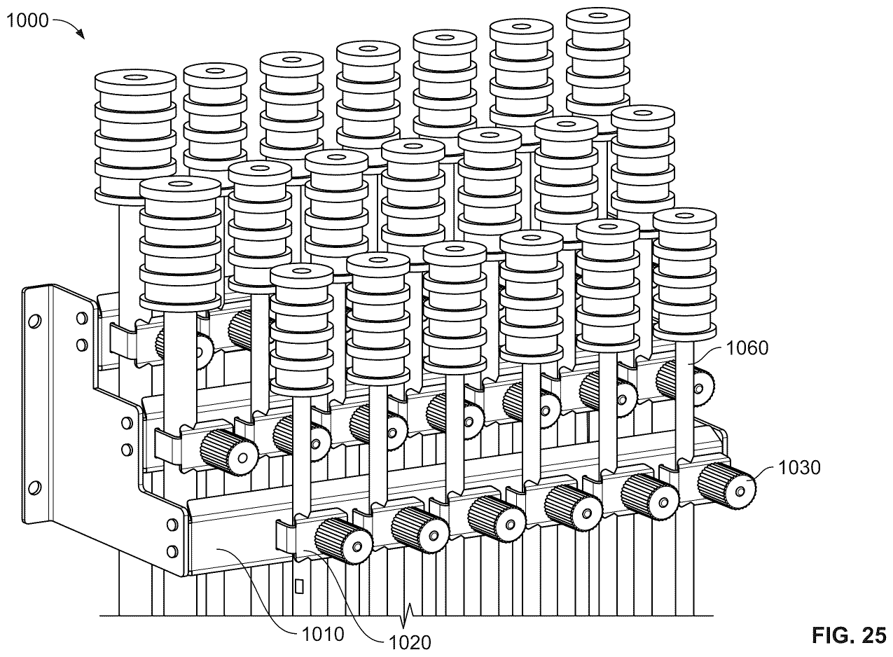

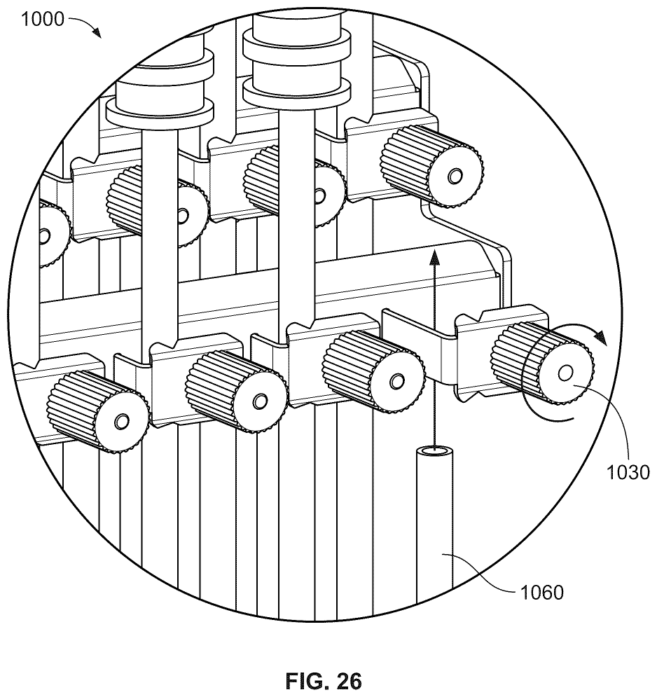

Referring now to FIGS. 25-26, in operation, a cable or duct 1060 is positioned below the retention clip 1020 and adjacent to the support strap 1010 prior to tightening. The threaded nut 1030 is rotated by hand in a first rotational direction, causing the threaded nut 1030 to move axially along the threaded stud 1012 toward the support strap 1010. As the threaded nut 1030 advances, the retention clip 1020 is forced against the cable or duct 1060, compressing the cable or duct 1060 between the retention clip 1020 and the support strap 1010 to provide restraint. The tooth features 1029 and bent edges 1028 of the retention clip 1020 grip the cable or duct 1060 to prevent movement.

To release the cable or duct 1060, the threaded nut 1030 is rotated by hand in a second rotational direction opposite the first rotational direction, causing the threaded nut 1030 to move axially along the threaded stud 1012 away from the support strap 1010. As the threaded nut 1030 retracts, the retention clip 1020 releases the cable or duct 1060, permitting removal or repositioning. No special tools are required to tighten or loosen the fastener system 1000.

The linear drive mechanism formed by the threaded engagement between the threaded nut 1030 and the threaded stud 1012 permits the fastener system 1000 to accommodate an infinite variation of cable or duct diameters within a range determined by the length of the threaded stud 1012 and the dimensions of the retention clip 1020. The fastener system 1000 may be scaled up or down for different applications requiring larger or smaller cable or duct retention. The fastener system 1000 is configured to restrain cables or ducts having various cross-sectional profiles. In some embodiments, the fastener system 1000 restrains round cables or ducts. In other embodiments, the fastener system 1000 restrains flat cables or drop profiles. The retention clip 1020 may be shaped to conform to the profile of the cable or duct being retained.

In some embodiments, a single retention clip 1020 is configured to restrain a plurality of cables or ducts 1060 simultaneously. The retention clip 1020 may be dimensioned to span across multiple cables or ducts 1060 arranged side-by-side, compressing the plurality of cables or ducts 1060 against the support strap 1010 when the threaded nut 1030 is tightened. In some embodiments, a single threaded nut 1030 is used to secure the retention clip 1020 against the plurality of cables or ducts 1060. In other embodiments, a plurality of threaded nuts 1030 are engaged with the retention clip 1020, each threaded nut 1030 corresponding to a respective threaded stud 1022, to provide distributed clamping force across the width of the retention clip 1020. The use of multiple threaded nuts 1030 permits independent adjustment of clamping force at different locations along the retention clip 1020, which may be advantageous when restraining cables or ducts 1060 of varying diameters or when a more uniform clamping force distribution is desired.

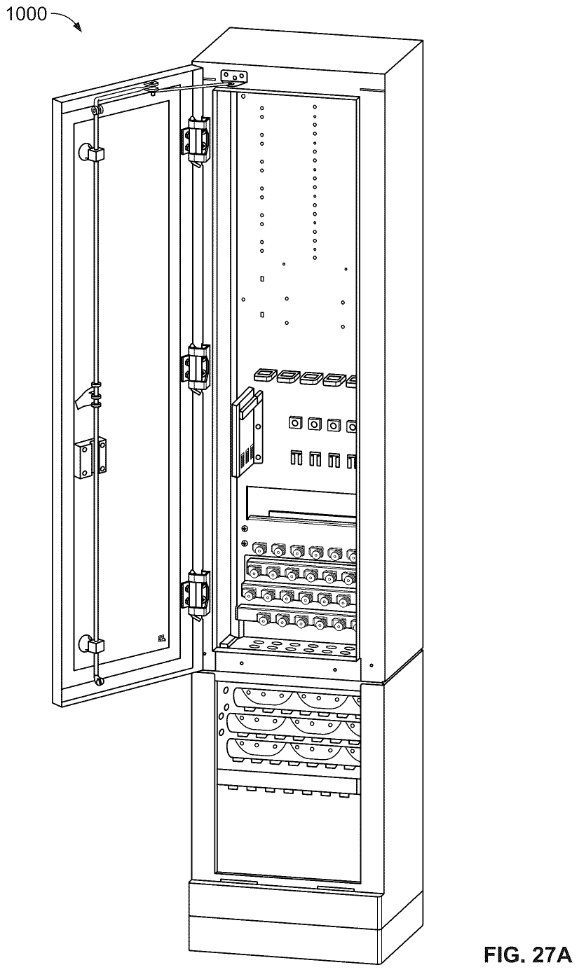

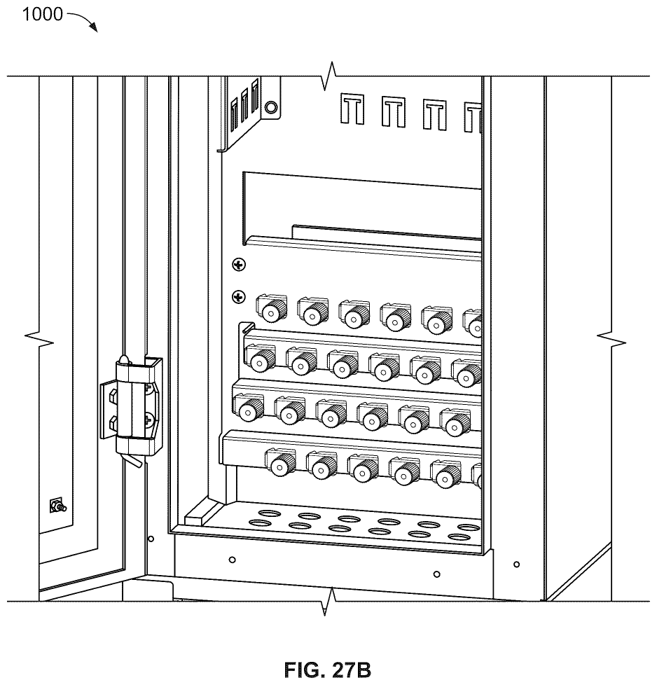

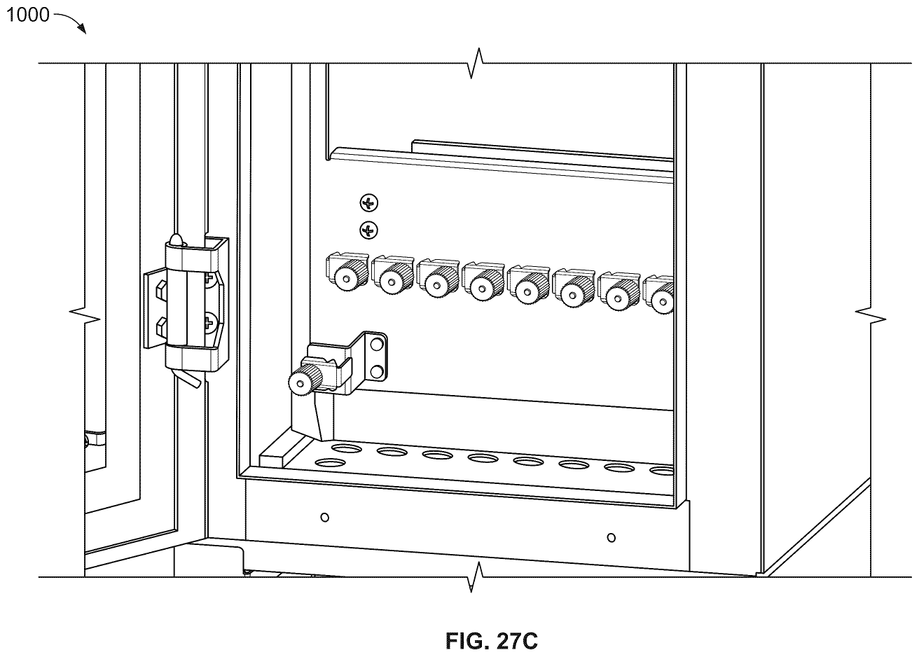

Referring now to FIGS. 27A-C, in some embodiments, a plurality of fastener systems 1000 are arranged in a modular configuration to support high-density cable management. The plurality of fastener systems 1000 may be mounted to a common support structure, such as a module rack or interior panel, with the retention clips 1020 arranged to support a plurality of cables or ducts. In some embodiments, the modular configuration supports between about 21 and about 27 cables or ducts, depending on the spacing and dimensions of the fastener systems 1000.

In some embodiments, the support strap 1010 is configured to be mounted directly to an internal panel of a cabinet assembly without a separate supporting frame. In some embodiments, the support strap 1010 is configured to be mounted to an offset bracket extending from the cabinet assembly to position the fastener system 1000 at a desired location relative to the cables or ducts.

Although the embodiment illustrated in FIGS. 20-27 depicts a threaded clamping mechanism as the linear drive mechanism, other linear drive mechanisms may be substituted. For example, in some embodiments, the linear drive mechanism comprises a rack and pinion mechanism in which rotation of a pinion gear drives a rack coupled to the retention clip 1020 in a linear direction. In other embodiments, the linear drive mechanism comprises a cam mechanism in which rotation of a cam drives the retention clip 1020 toward or away from the support strap 1010. In still other embodiments, the linear drive mechanism comprises a lever mechanism that converts pivoting motion into linear displacement of the retention clip 1020. Each of these alternative linear drive mechanisms provides infinitely adjustable clamping force within a predetermined range.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising.”

Further, unless specified otherwise, “first,” “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various embodiments of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A fastener system, comprising
a support structure;
a retention clip comprising a support portion configured to be disposed in a slot of the support structure; and
a linear drive mechanism configured to convert an input motion into linear displacement of the retention clip toward or away from the support structure to clamp or release a cable or duct between the retention clip and the support structure.

2. The fastener system of claim 1, wherein the linear drive mechanism comprises a threaded clamping mechanism including a threaded stud and a threaded nut, wherein rotation of the threaded nut causes the threaded nut to move axially along the threaded stud to drive the retention clip toward or away from the support strap.

3. The fastener system of claim 2, wherein the threaded nut includes a body having a threaded hole extending through a center of the body, and a groove formed in an exterior surface of the body, the groove configured to engage with a clip slot defined by the retention clip.

4. The fastener system of claim 3, wherein a width of the clip slot is slightly larger than a thickness of the retention clip to permit free rotation of the threaded nut relative to the retention clip after assembly.

5. The fastener system of claim 2, wherein the threaded nut includes an external surface geometry configured to provide an installer with additional grip when tightening or loosening the threaded nut, the external surface geometry comprising a knob extending radially from the body.

6. The fastener system of claim 1, wherein the retention clip includes one or more teeth configured to compress against and grip the cable or duct.

7. The fastener system of claim 1, wherein a single retention clip is configured to restrain a plurality of cables or ducts simultaneously.

8. The fastener system of claim 1, wherein the retention clip comprises a plurality of linear drive mechanisms.

9. A fastener, comprising:
a base that defines a plurality of slots arranged at different positions;
a cover fixed with the base, wherein the base and the cover define a hole configured for receiving a cable in a longitudinal direction of the fastener; and
a clip that includes a first clip end disposed in one of the plurality of slots, and includes a second clip end extended from the first clip end, toward the cover, and into the hole in a direction perpendicular to the longitudinal direction,
wherein the clip pivots between a locked position and an unlocked position with respect to the cover when the cable is pushed or pulled through the hole.

10. The fastener of claim 9, wherein the plurality of slots are configured to retain the clip at a variety of distances from an interior surface of the cover.

11. The fastener of claim 9, wherein the plurality of slots are offset from each other in the longitudinal direction of the fastener in regular intervals, and arranged at a variety of positions in a front-back direction of the fastener.

12. The fastener of claim 9, wherein the second clip end forms a concave edge along an outer perimeter of the clip, the concave edge configured to increase a contact surface between the second clip end and the cable.

13. The fastener of claim 9, wherein the base includes prongs configured to snap fit with a support structure for mounting the fastener.

14. The fastener of claim 9, wherein the cover includes guide rails configured to slide into guide channels defined by the base to fix the cover with the base.

15. The fastener of claim 9, wherein the cover includes cover tabs configured to restrict longitudinal movement of the cover relative to the base.

16. A fastener, comprising:
a base including base inner walls that define an interior, the base inner walls including a pair of base side walls extended in a front-back direction, and a base back wall extended between the base side walls in a left-right direction; and
a wedge having a first flange and a second flange extended oppositely from each other in the left-right direction,
wherein the base side walls define channels that extend at an angle offset from vertical in the front-back direction, and the channels are configured to receive the flanges in a sliding relationship that drives the wedge toward the base back wall in the front-back direction.

17. The fastener of claim 16, further comprising a locking mechanism configured to prevent the wedge from moving away from the base back wall.

18. The fastener of claim 17, wherein the locking mechanism comprises a clamp having prongs with ridges configured to snap-fit within detents defined by the base side walls.

19. The fastener of claim 16, further comprising a locking mechanism comprising pawls extending from lateral sides of the wedge, the pawls configured to engage with teeth defined by the base side walls in a ratcheting relationship.

20. The fastener of claim 16, wherein the wedge defines a passage configured to receive a clip, the clip having a blade configured to extend beyond a wedge back surface to engage a cable with concentrated grip force.
